(19) United States
(12) Patent Application Publication
(10) Pub. No.: US 2020/0254385 A1
(43) Pub. Date: Aug. 13, 2020

(54) SYSTEM AND METHODS FOR STORAGE OF PERISHABLE OBJECTS

(71) Applicant: PENDRAM, INC., San Diego, CA (US)

(72) Inventors: Jonathan SIANN, San Diego, CA (US); Wilson C. NG, San Diego, CA (US)

(21) Appl. No.: 16/637,708

(22) PCT Filed: Aug. 8, 2018
(86) PCT No.: PCT/US2018/045863

§ 371 Date: Apr. 27, 2020

Related U.S. Application Data
(60) Provisional application No. 62/542,414, filed on Aug. 8, 2017.

(51) Int. Cl. B01D 53/26; F25B 21/04

(52) U.S. Cl. CPC B01D 53/265; F24F 2110/10; F25B 2321/023; F25B 21/04

(57) ABSTRACT

Systems and methods for storing a perishable object are provided. An example system comprises an enclosure body forming a cavity and a lid which removably engages with at least a portion of the enclosure body to form a chamber enclosing a perishable object. The system also comprises a thermal insulator disposed within the cavity, a temperature control system disposed within the cavity to adjust a temperature of the environment based on a target temperature range associated with the perishable object, a humidity control system disposed within the cavity, the humidifying system comprising a heating element in contact with a liquid to adjust a humidity of the environment based on a target humidity range associated with the perishable object.

### RELATED APPLICATION

The present application claims priority to U.S. Provisional Application No. 62/542,414, filed Aug. 8, 2017, which is incorporated herein by reference in its entirety.

### BACKGROUND

### Field of the Invention

The present disclosure relates to perishable object storage systems, and more specifically, to systems for storing perishable objects and methods for regulating storage environments.

### Related Art

Conventional approaches to storage of perishable objects is to place the object in a sealed non-porous container and deposit the storage container in a freezer, refrigerator, or on a table top. The conditions established by the freezer and refrigerator are commonly at 0° C. and 7° C., respectively. The relative humidity may be near 10%, as moisture is typically condensed away. Table top storage leaves the perishable object open to general and uncontrolled atmospheric conditions. Generally, the conditions seen on the table top environments range depending upon the geographic location of the table, but temperatures are typically 22° C. and humidity may range from 10% to 100%.

Current implementations of systems for storing perishable objects fail to account for various relevant factors to provide simple to use, effective, efficient, precise, low microorganism and low observability systems for storing and presenting the perishable objects. For example, these systems typically consist of an under-the-counter sized refrigerator and a number of after-market temperature sensors. The temperature sensors control AC switches for activating the refrigerator's cooling unit and for activating a heating element. Off-the-shelf retail refrigerators are optimized for maintaining the typical refrigerator temperature range from 1° C. to 7° C. However, this range is outside of the optimal range for many perishable objects, such as consumable goods which could become unappetizing or inconsumable outside of optimal storage conditions.

Also, humidity control methods used in conventional systems range from placing open containers of water in the refrigerator to adding a humidity sensor and external plumbing to drip liquid water into the refrigerator. However, these systems fail to account for growth of microorganisms and bacteria that may grow in the environment.

Some current systems attempt to set a storage temperature above the typical refrigerators, by using a temperature sensor that actuates control relays to modulate a heating device between on and off. For example, some systems modulate a light bulb to warm the environment by turning it on and off to affect the temperature. This system also attempts to account for humidity levels by evaporation of the liquid water stored in the cups. However, the relative humidity in this case various from a low of 10% to a high of 80%.

Accordingly, what is needed is a system and method that overcomes the significant problems found in the conventional solutions described above.

### SUMMARY

Aspects of the present application may relate to a system for storing a perishable object. The system comprises an enclosure body comprising a housing including a base and at least one sidewall forming a cavity; a lid, which removably engages with at least a portion of the enclosure body to form a chamber enclosing an environment surrounding the perishable object; and a thermal insulator disposed within the cavity. The system also comprises a temperature control system disposed within the cavity to adjust a temperature of the environment based on a target temperature range associated with the perishable object. The temperature control system comprises one or more heat pumps, and a first heat exchanger thermally coupled to the environment, at least a part of the first heat exchanger positioned apart from the one or more heat pumps by the thermal insulator and thermally coupled to the one or more heat pumps via a conduit extending through the thermal insulator. The system further comprises a humidity control system disposed within the cavity, the humidifying system comprising a heating element in contact with a liquid to adjust a humidity of the environment based on a target humidity range associated with the perishable object.

Additional aspects of the present application may relate to a method for regulating an environment surrounding a perishable object. The method comprises determining target environmental conditions of the environment based on a desired environment of the perishable object, the target environmental conditions comprising a target temperature and a target humidity, wherein the perishable object is enclosed in a lid removably engaged with at least a portion of an enclosure body to form a chamber comprising the environment. The method also comprises driving one or more heat pumps thermally coupled to the environment to adjust a temperature of the environment based, in part, on a temperature difference between a current temperature of the environment and the target temperature; and driving one or more heating elements to vaporize an amount of liquid and adjust a humidity in the environment, the amount of liquid based, in part, on a humidity differential between a current humidity in the environment and the target humidity.

Further aspects of the present application relate to a system for regulating temperature of an environment for a perishable object. The system comprises one or more heat pumps driven by an electrical power source to adjust a temperature of the environment based on a target temperature range associated with the perishable object. The system also comprises a first heat exchanger comprising a thermally conductive plate thermally coupled to the environment and having an upper portion and a lower portion, the thermally conductive plate positioned between the environment and the one or more heat pumps. The thermally conductive plate is separated from the one or more heat pumps by a thermal insulator and thermally coupled to the one or more heat pumps via a conduit extending through the thermal insulator, wherein the perishable object is surrounded by the environment.

Another aspect of the present application relates to a method for regulating temperature of an environment surrounding a perishable object. The method comprises determining a target temperature for the environment based on a desired temperature for the perishable object, wherein the perishable object is enclosed in a lid removably engaged with at least a portion of an enclosure body to form a chamber enclosing the environment. The method also includes driving at least a first heat pump thermally coupled to the environment to adjust the temperature of the environment based, in part, on a first temperature difference between a first temperature in the environment and the target temperature.

Further aspects of the present application relate to a system for regulating humidity of an environment surrounding a perishable object. The system comprises a first chamber comprising a first partition wall, the first partition wall having a first opening, wherein the first chamber is arranged to receive liquid via the first opening. The system also includes a heating element disposed within the first chamber above a bottom surface of the first chamber; and an article engaged with the heating element and extending toward the bottom surface of the first chamber, wherein the article is arranged to draw liquid via capillary action toward the heating element. The heating element is configured to heat at least a portion of the drawn liquid to a first temperature to generate vapor, wherein the portion of the drawn liquid is based on a target humidity range associated with the perishable object.

Still further aspects of the present application relate to a method for regulating humidity of an environment surrounding a perishable object. The method comprises determining target humidity for the environment based on a desired humidity for the perishable object, wherein the perishable object is enclosed in a lid removably engaged with at least a portion of an enclosure body to form a chamber enclosing the environment. The method also includes determining whether to increase or decrease humidity in the environment based on a humidity differential between a current humidity in the environment and the target humidity, and driving one or more heating elements to vaporize an amount of liquid and adjust humidity of the environment based on said determination.

Other features and advantages of the present application will become more readily apparent to those of ordinary skill in the art after reviewing the following detailed description and accompanying drawings.

### BRIEF DESCRIPTION OF THE DRAWINGS

The structure and operation of embodiments of the present application will be understood from a review of the following detailed description and accompanying drawings in which like reference numerals refer to like parts and in which:

FIGS. 1A-1D are various view diagrams illustrating an example storage system according to various embodiments of the present application;

FIG. 2 is a perspective view diagram illustrating an example cap according to various embodiments of the present application;

FIG. 3 is a perspective view diagram illustrating example systems for use in embodiments of a storage system according to various embodiments of the present application;

FIGS. 4A-4E are various view diagrams illustrating an example temperature control system according to an embodiment of the present application;

FIGS. 5A-5C are various view diagrams illustrating another example temperature control system according to an embodiment of the present application;

FIG. 6 is a perspective view diagram illustrating an example collection element according to various embodiments of the present application;

FIG. 7 is a cross-section perspective view diagram illustrating an example humidity control system according to various embodiments of the present application;

FIG. 8 is a schematic diagram illustrating another example humidity control system according to various embodiments of the present application;

FIG. 9 is a flow chart illustrating an example process for regulating an environment surrounding a perishable object in accordance with various embodiments of the present application;

FIG. 10 is a flow chart illustrating an example process for regulating temperature in an environment in accordance with various embodiments of the present application;

FIG. 11 is a flow chart illustrating another example process for regulating temperature in an environment in accordance with various embodiments of the present application;

FIG. 12 is a flow chart illustrating an example process for regulating humidity in an environment in accordance with various embodiments of the present application;

FIG. 13 is a flow chart illustrating an example sub-process for regulating humidity in an environment in accordance with various embodiments of the present application;

FIG. 14 is a flow chart illustrating another example process for regulating humidity in an environment in accordance with various embodiments of the present application;

FIG. 15 is a schematic block diagram illustrating an example processing system for use in one or more of the systems described herein in accordance with various embodiments of the present application.

### DETAILED DESCRIPTION

Certain embodiments herein provide for systems and methods for storing perishable objects in a controlled and regulated environment. The embodiments herein provide for regulating the environment based on target environmental conditions, such as temperature and humidity levels, that are dependent on the perishable object being stored. The target conditions may represent optimal environmental conditions for maintaining quality and condition of the perishable object. Certain embodiments also accommodate display and/or viewing of the perishable objects while stored in a package having low and unobtrusive profile. After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

The following detailed description provides further details of the figures and example implementations of the present application. Reference numerals and descriptions of redundant elements between figures may be omitted for clarity. Terms used throughout the description are provided as examples and are not intended to be limiting. For example, the use of the term “automatic” may involve fully automatic or semi-automatic implementations involving user or operator control over certain aspects of the embodiments, depending on the desired implementation of one of ordinary skill in the art practicing embodiments of the present application. Further, sequential terminology, such as “first”, “second”, “third”, “top”, “bottom”, etc., may be used in the description and claims simply for labeling purposes and should not be limited to referring to described actions or items occurring in the described sequence. Actions or items may be ordered into a different sequence or may be performed in parallel or dynamically, without departing from the scope of the present application.

In the present application, the term “perishable object” may be used to described an item stored within the systems described herein. The term “perishable object” may refer to any goods, items, objects, articles, devices, things that may decay, deteriorate, degrade, rot, go bad, mold, corrode, perish, etc. over time or otherwise. Example perishable objects, include but are not limited to consumable goods, biodegradable goods, metal (e.g., corrosion), and the like. Description herein may be made to certain consumable goods, such as cheese, sushi, etc., for example but not limited to, Manchego, Brie, blue or cheese. However, it will be appreciated that the scope of the present disclosure is not so limited, and may apply, within the knowledge of one skilled in the art, to any perishable object.

Certain objects or goods may perish due to environmental and/or atmospheric conditions, such as, but not limited to, temperature, humidity, water, bacteria, microorganisms, electromagnetic exposure, chemical reactions, etc. For example, storage conditions such as high humidity and certain temperatures may facilitate bacterial and other microorganism growth that can cause perishable objects to perish. Thus, each perishable object may correspond and/or be associated with a plurality of desired environmental conditions, including but not limited to, a desired temperature and a desired humidity. The terms “desired”, “target”, “optimal”, “preferred” and the like may be used interchangeably to describe the environmental conditions corresponding to the perishable good. For example, Manchego cheese may be associated with or correspond to a target or desire environment comprising a temperature of 12° C. and a humidity level of 80%. Example environmental conditions for a plurality of cheeses are provided in Table 1.

TABLE 1
GENERAL TEMPERATURE AND HUMIDITY
GUIDELINES BY STYLE OF CHEESE:

| | |
|---|---|
| FRESH CULTURE-RIPENED | BLOOMY RIND (OTHER THAN |
| (No bloom on surface) 50-55° F. @ 80% | BLUES) |
| humidity. | Pasteurized Cow's or Mixed Mild: |
| | 50-55° F. @ 90-95% humidity |
| | Goat's Milk or Raw Milk: |
| | 48-50° F. @ |
| | 90-95% humidity |
| SALT-RUBBED OR BRINED | SURFACE-RIPENED |
| 50-55° F. @ 80-85% humidity; Chilled in | 50-55° F. @ 92-95% humidity |
| 50-55° F. brine. | |
| If stored in refrigeration, 38-40° F. @ | |
| 65% humidity (as in home refrigerator). | |
| PASTA FILATA | MOLD-RIPENED |
| Depending upon finished style, 60-62° F. | 50-55° F. @ 92-95% humidity |
| @ 80-85% humidity. | |
| Some are aged at 50-55° F. @ 92-95% | |
| humidity. | |
| If stored in refrigeration, 38-40° F. @ | |
| 65% humidity (as in home refrigerator). | |
| SEMI-SOFT | WASHED & SMEARED |
| 60-62° F. @ 80-85% humidity. | Smeared (b.Linens): 50-52° F. @ 92- |
| Firm: Natural Rind cheeses: 50-55° F. @ | 95% humidity |
| 90-92% humidity. | Washed: 50-52° F. @ 85-90% humidity |
| Hard: 50-55° F. @ 85-95% humidity | Soft-ripened washed: 55-60° F. @ 90- |
| | 95% humidity |
| | Pressed, Hard Rind: 50-55° F. @ 92- |
| | 95% humidity |
| CLOTHBOUND | BLUES |
| 50-55° F. @ 65-75% humidity. | Bloomy: 50-55° F. @ 90-92% humidity |
| Waxed: 40-45° F. @ 85% humidity OR | Pressed: 50-55° F. @ 80-85% humidity |
| 50-55° F. @ 85-90% humidity | Veined: 50-55° F. @ 85-90% humidity |
| | If foil-wrapped, 40° F. @ 85% humidity |

For example, some perishable objects, such as cheese, are often stored by consumers in refrigerators with low humidity and they therefore often use plastic wrapping to maintain the moisture. However the plastic may prevent airflow around the cheese which can trap excess moisture against the cheese surface. These air tight and wet conditions can promote growth of unhealthy or foul tasting bacteria and other microorganisms while inhibiting the “good” cheese molds, and this combination of effects may rapidly spoil the cheese. Certain embodiments herein may provide an air layer that may move with high humidity (but not wet conditions) at temperatures around 10° C. to 14° C., which may be desired conditions to store cheese. Furthermore, this environment may potentially age the cheese further, which may not only maintain but enhance the flavor of the cheese

In the present application, the term “fluid” may be used to described any substance that is able to flow and/or does not comprise a fixed shape. For example, the term “fluid” may refer to a gaseous substance and/or a liquid. Accordingly, the term “fluid flow” may refer to any fluid current or fluid flow corresponding to a given substance. For example, a fluid that is in a gaseous state may comprise a fluid flow and a fluid in a liquid state may correspond to a liquid flow. Example gases herein may include, but not limited to, air (including N₂, O₂, CO₂, water, etc. in gaseous forms), vapored liquids (include, water vapor, ethylene vapor, etc.). Other examples include nitrogen, argon, xenon, oxygen, and/or compounds including the same. Example liquids, include, but not limited to, liquid water, ethanol, etc.

Embodiments herein account for several relevant factors. For example, storage systems described herein should be effective in controlling the environment. The environmental conditions, such as temperature, humidity, and gaseous composition may be predetermined based on the perishable object stored such that the storage system may determine target conditions. Furthermore, certain embodiments herein provide for a reduced energy usage footprint. Inefficiencies result in excess energy that exits the design, excess physical size, excess energy consumed completing extraneous tasks. Thus, the various features described herein may be implemented to reduce these inefficiencies. Further still, embodiments herein should be aesthetically pleasant. The perishable object may be displayed. The storage system may be discrete both in visual (e.g., unobtrusive, low profile, etc.) and acoustic characteristics (e.g., reduce noise during operation). Additionally, embodiments herein provide for sanitary storage environments that are easy to clean and resist the growth of microorganism.

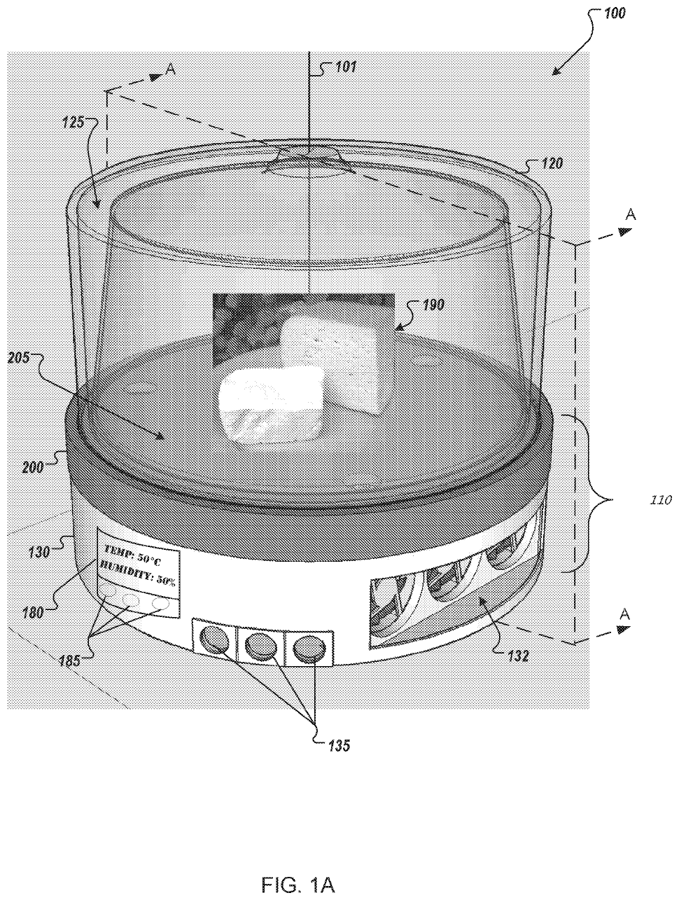

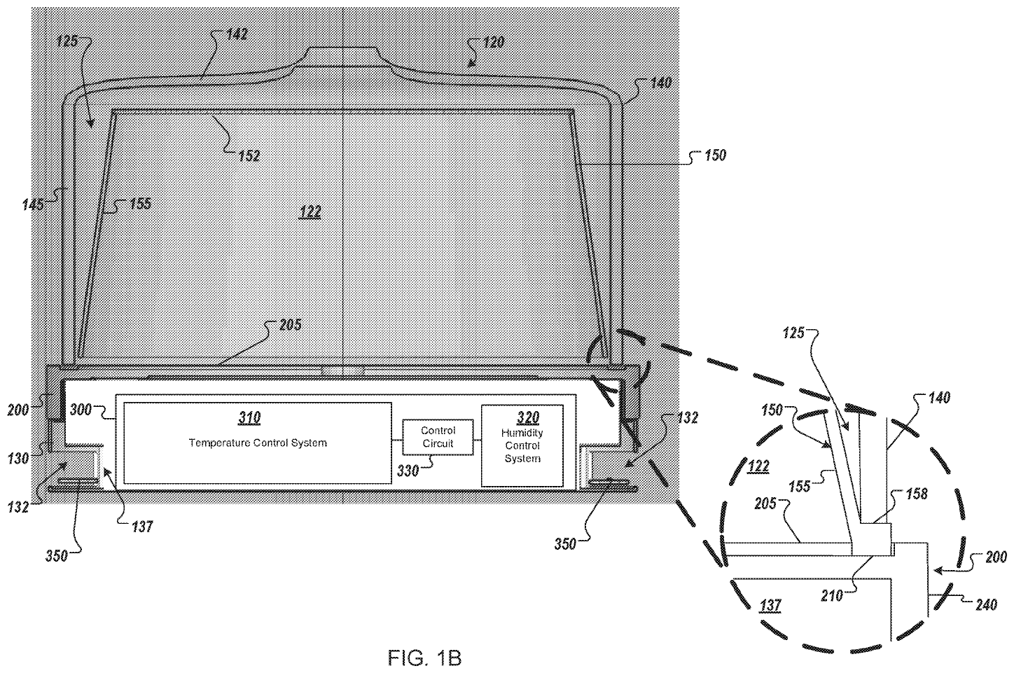

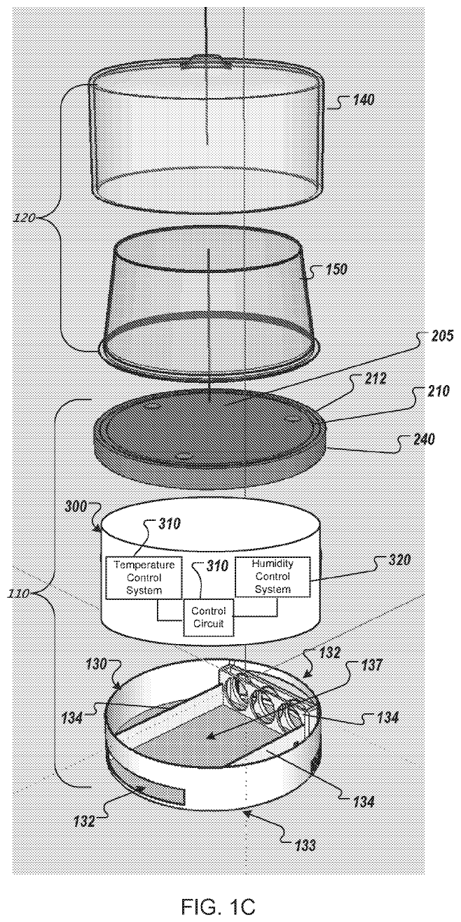

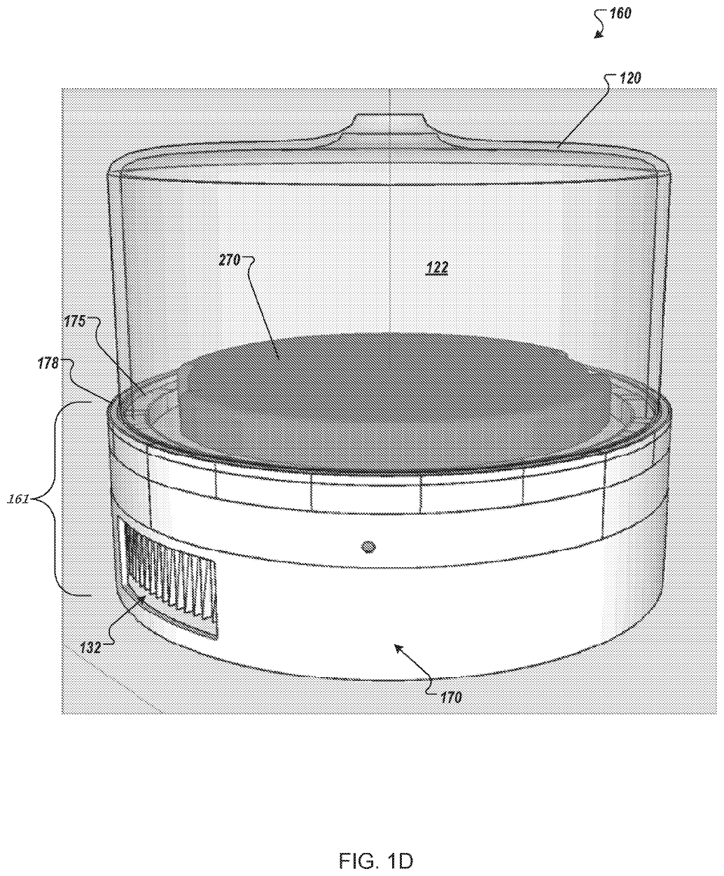

FIGS. 1A-1C are various view diagrams illustrating a storage system 100 according to various embodiments of the present application. FIG. 1A is a perspective view diagram illustrating the storage system 100. FIG. 1B is a side view diagram of the storage system 100 illustrated a cross-section taken along a cross section A-A depicted in FIG. 1A. FIG. 1C is an exploded perspective view diagram of the storage system 100 according to an embodiment of the present application. While an example implementation is illustrated in FIGS. 1A-1C, other configurations are possible without departing from the scope of the novel features disclosed herein.

In the illustrated embodiment, the storage system 100 has a circular shape having a center along a virtual vertical axis 101. The storage systems herein are not to be limited to circular shapes only, and other shapes are possible. For example, square, rectangular, etc. The overall shape of the storage system 100 may be based on the perishable object 190 stored therein. For example, where the perishable object 190 is cheese as illustrative shown in FIG. 1A, a circular shape may be desired. On the other hand, if the perishable object 190 is sushi or a loaf of bread, a rectangular shape may be desired. Thus, one skilled in the art would recognize that any shape of the storage system 100 may be utilized based, in part, on the perishable object stored therein.

In the illustrated embodiment, storage system 100 comprises an enclosure body 110 comprising a housing 130 including a base 133 and at least one sidewall 136 forming a cavity 137. In various embodiments, the enclosure body has a height along axis 101 of approximately 80 mm or less, preferably approximately 60 mm or less, and/or more preferably approximately 40 mm or less. In some embodiments, the perishable object may be positioned on a surface that is approximately 80 mm or less from the base 133 of the housing 130 along the axis 101, preferably approximately 60 mm or less, and/or more preferably approximately 40 mm or less. In general, the lower the overall height of the storage system 100 the more appealing it may be to consumers due to, for example, an ability to place the storage system 100 under cabinets and/or improved visual aesthetics. Storage system 100 also comprises a lid 120 removably engaged with at least a portion of the enclosure body 110 to form a chamber 122 enclosing an environment surrounding the perishable object 190. As illustrated in FIGS. 1B and 1C, the cavity 137 may comprise environmental control systems 300 disposed within the cavity, including computing devices, memory, sensors, and other control circuitry and machinery as described herein. The storage system 100 may be configured to thermally couple the chamber 122 with cavity 137 and the environment control systems 300 therein, for example, to sense and regulate environmental conditions of the environment based on the perishable object being stored.

In accordance with various embodiments herein, the environmental control system 300 may comprise a control circuitry 330, a temperature control system 310, and a humidity control system 320. As described herein, the temperature control system 310 may be controlled by the control circuitry 330 to adjust a temperature of the environment based on a target temperature range associated with the perishable object 190. Furthermore, the humidity control system 320 may be controlled by the control circuitry 330 (or a separate control circuitry) to adjust a humidity of the environment based on a target humidity range associated with the perishable object.

In certain embodiments, a temperature in the chamber 122 may be influenced by establishing flows of thermal energy into and out of the chamber 122. For example, when cooling the temperature chamber 122, a flow may be established from the chamber 122 to the cavity 137. When heating the temperature of the chamber 122, the flow may be reversed. A complete path of thermal flow when cooling may be from the exterior of the chamber 122, to the interior of the chamber 122, to the interior of the cavity 137, to the exterior of the cavity 137. When heating, the flow is reversed. By controlling the rate and direction of thermal energy flow, the temperature of the chamber 122 may be adjusted to target conditions of the perishable object stored.

Controlling the humidity within chamber 122 may be influenced by flows of vaporized liquid. For example, when increasing the humidity in the chamber 122, a flow of vaporized liquid is to the chamber 122 from the cavity 137. By controlling the rate and direction of vapor fluid flow, the humidity of the chamber 122 may be adjusted to target conditions of the perishable object stored. In various embodiments herein, the liquid may be, but not limited to, water and/or ethanol, and more preferably water. Thus, corresponding liquid vapor may be water vapor and/or ethylene vapor.

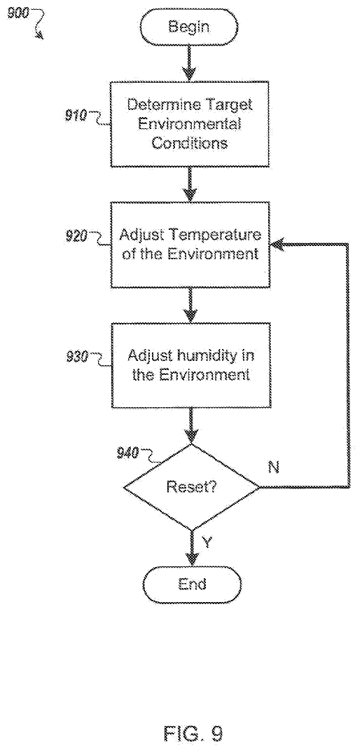

The environmental control systems 300 comprise (as described in greater detail herein) various conductors of thermal energy and a plurality of sensors 350 (e.g., temperature sensors, humidity sensors, acoustic sensors, light sensors, etc.) for establishing and controlling the above-mentioned flows. For example, the temperature control system 310 may comprise a control circuitry 330 communicatively coupled to one or more temperature sensors (e.g., one of sensors 350). The control circuitry 330 may be configured to receive outputs from the temperature sensors and automatically adjust the temperature of the environment within the chamber 122 based, at least in part, on the outputs from the temperature sensors (further details are provided in connection to FIGS. 9-13 below). Similarly, the humidity control system 320 may comprise a control circuitry 330 communicatively coupled to at least one humidity sensor (e.g., sensors 350), and the control circuitry 330 may be configured to receive an output from the humidity sensor and adjust the humidity of the environment within the chamber 122 based, at least in part, on the output from the humidity sensor (further details are provided in connection to FIGS. 9-13 below).

Returning to FIGS. 1A-1C, the housing 130 may comprise one or more optional interior structures 134, one or more openings 132 (e.g., two openings as shown in the illustrated embodiment of FIGS. 1A-1C), and/or a plurality of optional ports 135. As will be described below in greater detail, openings 132 may be arranged on one or more sides of the housing 130. For example, openings 132 may be opposite each other, on the same side of each other, or different sides. Openings 132 may be configured as either an inlet opening or outlet opening for fluid flow (e.g., airflow or other gaseous flow). Interior structures 136 may be arranged to physically support and/or protect the circuitry and/or machinery of the environmental control systems 300. Ports 135 may be provided as power connectivity ports to supply power to the storage system 100. Ports 135 may also permit electrical connectivity to remote devices, such as, for example, a USB connection or the like. Thus, a user may be able to electrically connect the storage system 100 for control, software update, or troubleshooting.

The storage system 100 may comprise a user interface 180. The user interface 180 may be a display, such as a LCD, OLED, LED display or the like. The display 180 may provide the user information about the operation of the storage system. For example, the display 180 may be configured to present information representative of at current environmental conditions and/or set (e.g., target) conditions. In some embodiments, the display may indicate information related corresponding to the perishable object, for example, a type of object. The display may also be configured to display operational feed-back, such as an indication that the storage system 100 is operating as desired, is in an on/off state, or that there is an unexpected malfunction.

In some embodiments, the user interface 180 may comprise an input device configured to receive user control inputs from the user. Input devices may include, but are not limited to, buttons, knobs, icons, touch screen display, voice command input, or the like. Via the user interface 180, the user may be able to input information indicative of the perishable object, for example, specify what the perishable object is (e.g., cheese, sushi, etc.), details about the perishable object (e.g., soft/hard cheese, sushi including salmon or tuna, etc.), etc. The user may operate the input device to set target environmental conditions including temperature and/or humidity levels. The storage system 100 may receive the user input representative of the perishable object and retrieve target conditions (e.g., from a local database or communicatively coupled database via a wired or wireless connection). Accordingly, in some embodiments, the user interface 180 may be configured to receive information representative of the perishable object 190 and determine target environmental conditions based there from.

In the illustrated embodiment, the lid 120 may be configured to thermally and physically isolate the perishable object 190 and the environment within the chamber 122 from the atmosphere exterior to the storage system 100. In some embodiments, the lid 120 may comprise of multiple layers of thermally resistive layers (e.g., a double glazed configuration). For example, the lid 120 may include an outer lid 140 and an inner insert 150, having a gap 125 there between. In some embodiments, the outer lid 150 and/or inner insert 140 may comprise a double glaze configuration of its own for additional insulation. In some embodiments, the lid 120 may be substantially transparent to showcase the perishable object being stored. The lid 120, outer lid 140, and/or inner insert 150 may comprise a material having one or more of acrylic, glass, plastic, sapphire or aluminum oxide or the like, and more preferably acrylic, glass, and/or plastic.

In some embodiments, outer lid 140 may surround the inner insert 150 to enclose the gap 125 between the outer lid 140 and inner insert 150. For example, FIG. 1B illustrates a vertical sidewall 145 of the outer lid 140 surrounding an inclined side wall 155 of the inner insert 15. The inclined side wall 155 may be inclined at an acute angle relative to the side wall 155 to form the gap 125 having a cross section that increases further away from the cavity 137. FIG. 1B also depicts a lip 158 of the inner insert configured to accept the outer lid 140 via a friction fit, thereby forming a seal to enclose the gap 125. In another embodiment, the outer lid 140 may comprise a lip (not shown) configure to accept the inner insert 150 forming the gap 125. In some embodiments, the gap 125 comprises air or an insulating gas and a thickness configured to insulate the chamber 122 from external atmosphere including the avoidance of thermal energy flow due to convection properties.

In the illustrated embodiment, the enclosure body 110 may comprise a cap 200 disposed on top of the housing 120. In various embodiments, the cap 120 comprises a top surface 205 on which the perishable object may be positioned and a side wall 240 that engages with the housing 120. In some embodiments, the perishable object 190 may be placed directly on the top surface 205 or positioned within the chamber 122 above the top surface 205 (e.g., in a container or otherwise suspended). In some embodiments, the top surface 205 of the cap 200 is approximately 80 mm or less from the base 133 of the housing 130 along the axis 101, preferably approximately 60 mm or less, and/or more preferably approximately 40 mm or less

The cap 200 may be removable from the enclosure body 110. Thus, the cap 200 may be used to transit the perishable object 190 to and from the storage system 100 and permit easy access to the cavity 137 for cleaning and maintenance. Access to the cap 200 may be facilitated by removing the lid 120. The cap 200 may comprise various materials, for example, the cap 200 may comprise wood, marble, stone, metal, plastic, etc. The material of cap 200 may be based, for example, on facilitating improved thermal coupling between the chamber 122 and cavity 137 so to assist with control and detection of the environment in the chamber 122. Additionally, the material of the cap 200 may be selected based on, for example, a desired aesthetic appearance in relation to the perishable object, weight properties, and/or other characteristics.

FIGS. 1B and 1C illustrate an example implementation of the lid 120 engaging with the enclosure body 110, for example, via the cap 200. In the illustrated embodiment, the cap 200 comprises a groove 210 or recess. The groove 210 may be positioned near outer edge of the cap 200 having an outer lip 212 between the outer edge and the groove 210. As illustrated in FIG. 1B the groove 210 may be configured to accept the lid 120 to form the chamber 122. In the illustrated embodiment, the lip 158 of the inner insert 150 is positioned, via a friction fit, into the groove 210. Other configurations are possible, for example, the outer lid 140 may be positioned in the groove 210.

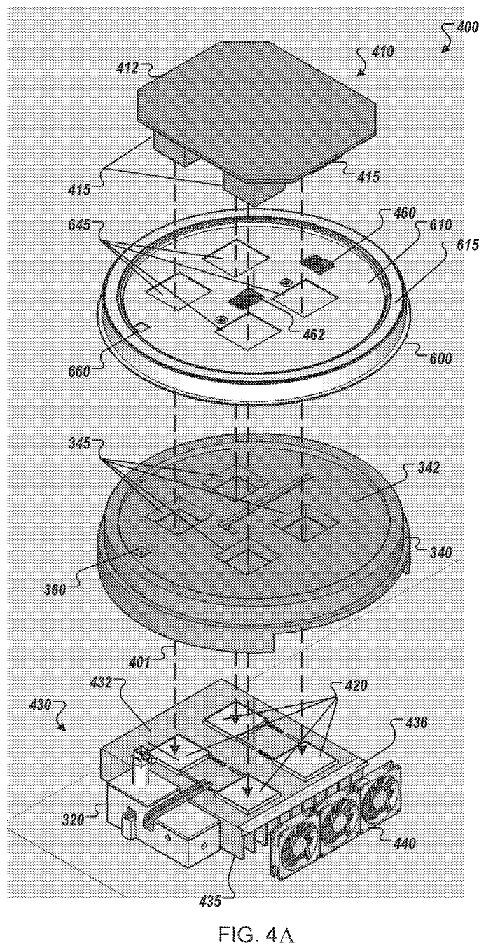

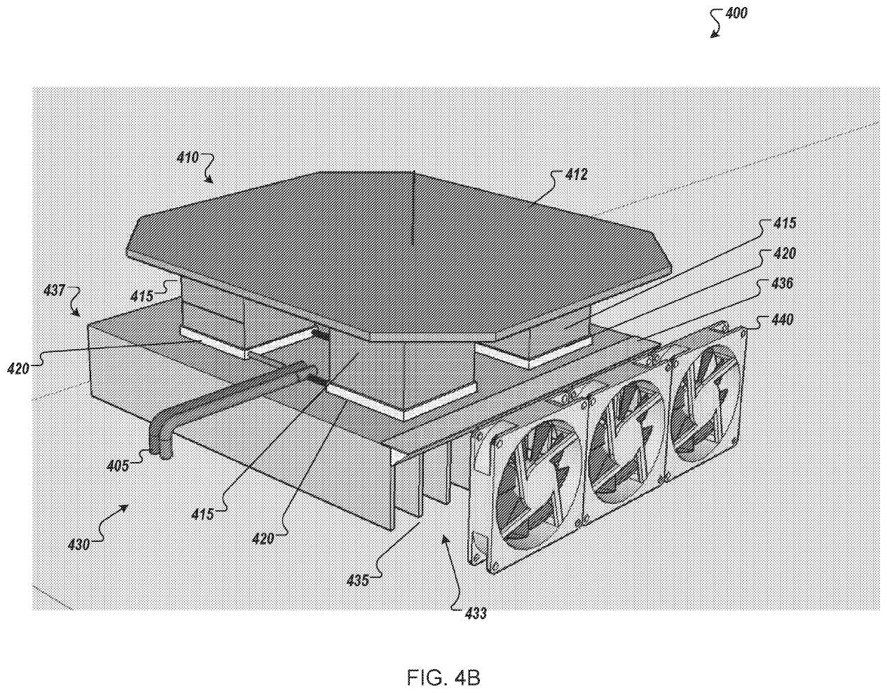

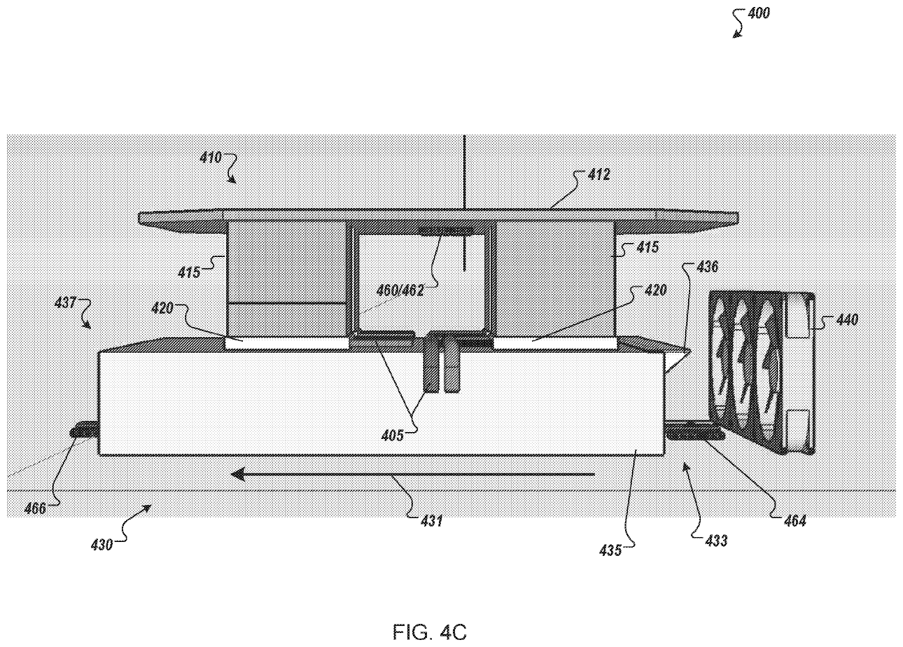

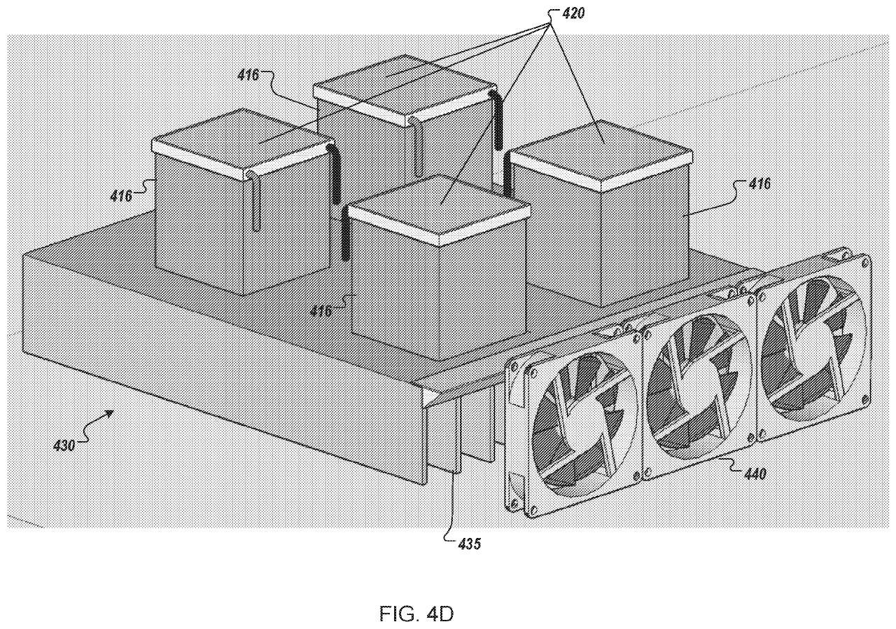

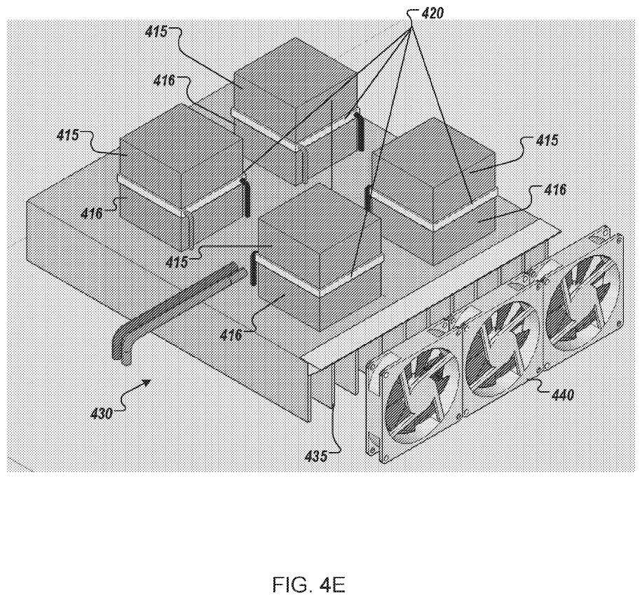

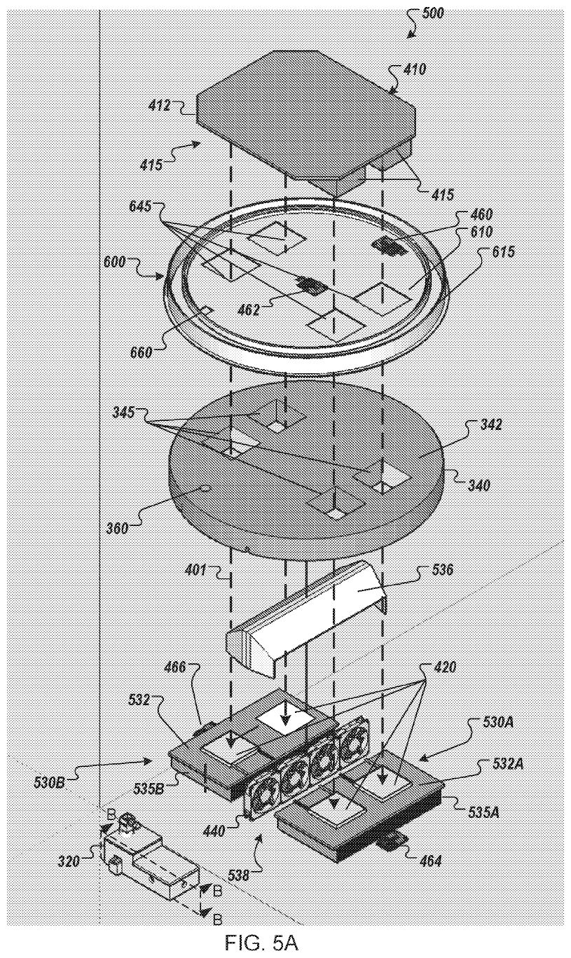

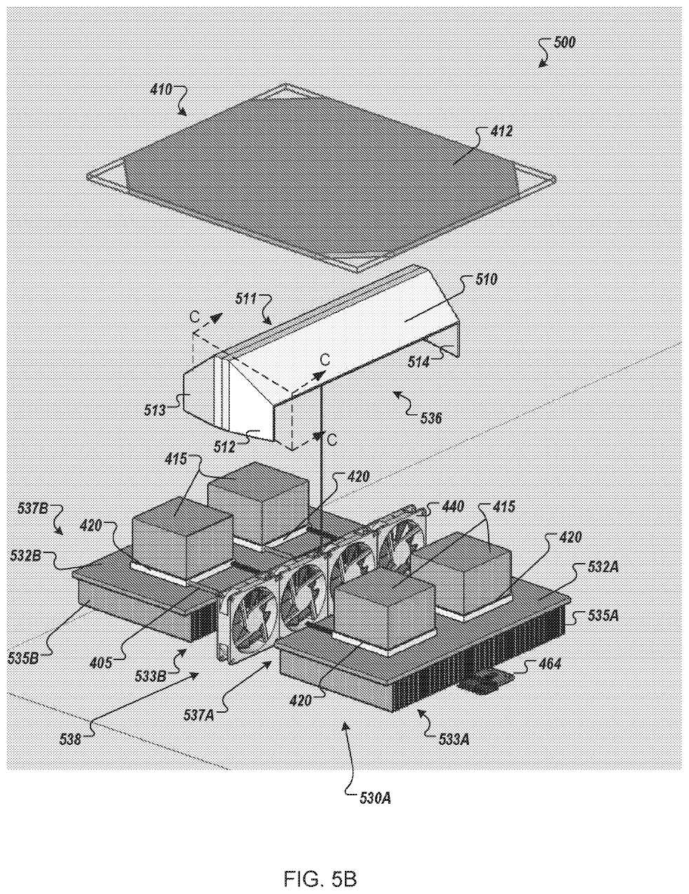

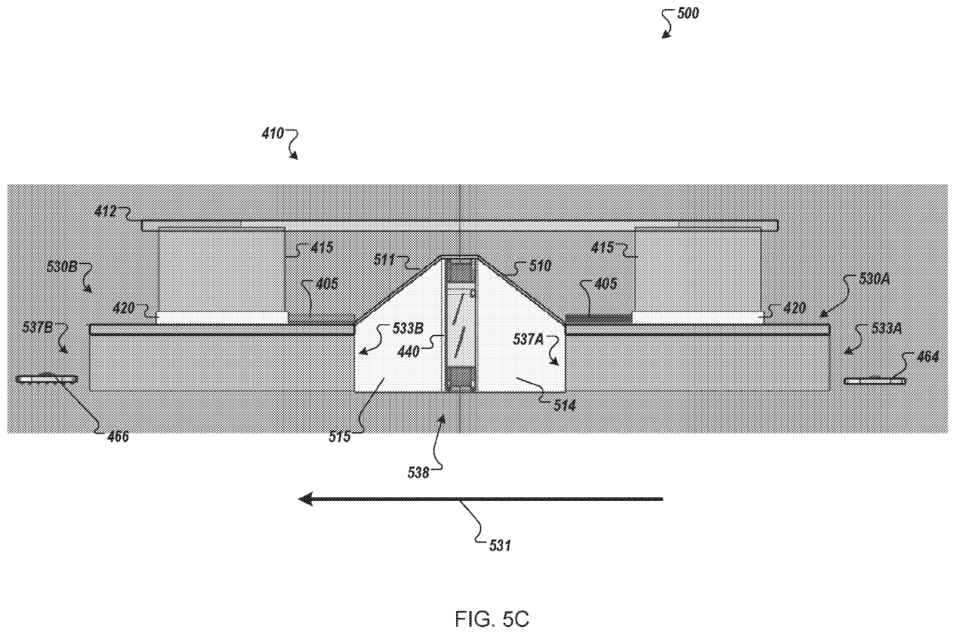

While FIGS. 1A-1C illustrate an example embodiment of the storage system 100, one skilled in the art will appreciate that various other configurations are possible. One or more of the various components of the storage system 100 may be omitted or additional components added without departing from the scope of the present application. For example, the cap 200 may be optionally omitted. In this embodiment, the perishable object 190 may be positioned above and/or on top of an upper portion of the environmental control systems 300 (e.g., a thermal conductive plate as described in connection to FIGS. 4A-5C) and the lid may engage the housing of the enclosure body 110 to form the chamber 122.

As another example, FIG. 1D illustrates a perspective view diagram illustrating a storage system 160 according to an embodiment of the present application. The storage system 160 may be substantially similar to the storage system 100 of FIGS. 1A-1C, except for the storage system 160 comprises an enclosure body 161 having a housing 170 and a cap 270 (which may be optional). The housing 170 may be substantially similar to housing 130, except that the housing 170 comprises a recessed region 175 and a lip 178 between the recessed region 175 and the side wall. The recessed region 175 may be configured to engage the lid 120 in a manner similar to that described above with respect to groove 210. Accordingly, cap 270 may be similar to cap 200, except that cap 270 may be surrounded by the lid 120 and enclosed within the chamber 122.

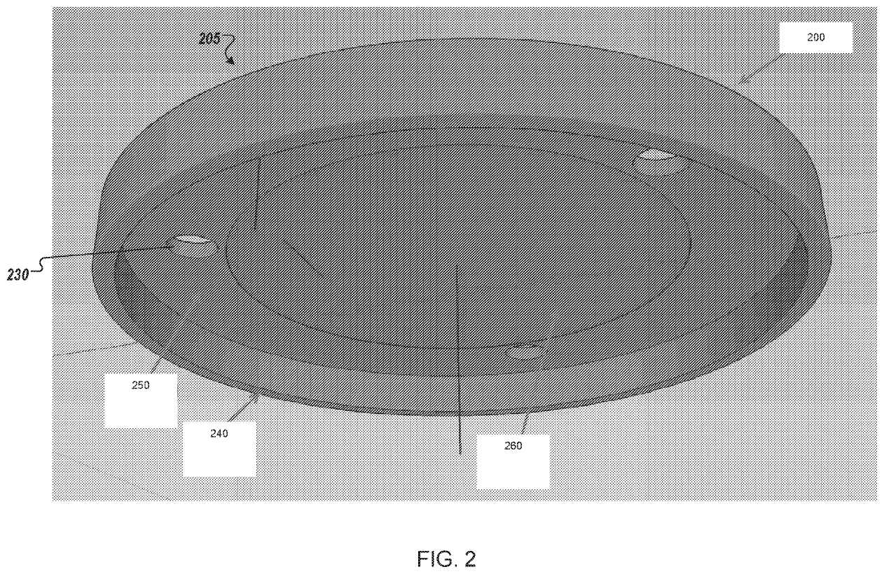

FIG. 2 is a perspective view diagram illustrating the cap 200 of FIGS. 1A-1C according to certain embodiments of the present application.

In the illustrated embodiment, the cap 200 may be a hollowed out cap comprising a hollowed region 250 (sometimes referred to herein as a “recess”) formed by side wall 240 that extends from the top surface 205 toward the housing 130. The side wall 205 may engage with the housing 170. For example, with reference to FIG. 1B, the side wall 240 of the cap may surround an outer surface of a portion of the side wall 136 of the housing. FIG. 1B illustrates the side wall 136 as comprising a stepped shaped such that a portion of the side wall 136 that is not engaged with the cap 200 forms a flush or substantially flush surface with the cap 200. Alternatively, the side wall 136 and side wall 240 need not form a flush surface. In another embodiment, a portion of an outer surface side wall 240 of the cap 200 may surrounded by the side wall 136 of the housing.

In the illustrated embodiment, the recess 250 may engage with the cavity 137 to encompass the environmental control systems 300. Accordingly, a cap 20 having the hollowed recess 250 may reduce the overall height of the enclosure body 110 along the vertical axis 101. For example, a cap that does not include a hollowed recess would sit atop the environmental control systems 300 thereby extending the height of the entire storage system. Furthermore, the hollowed recess permits for additional space for the environmental control systems 300 within the cavity 137 without foregoing appearance and/or usage of the cap 200 as a surface for the perishable object 190.

In some embodiments, the cap 200 may comprise a plurality of through holes 230 extending from the top surface 205 and toward the environmental control system 300 through the cap 200. The through holes 230 may be configured to facilitate thermal energy flow through improved thermal coupling of the cavity 137 and environmental control systems 300 to the environment within the chamber 122. For example, the through holes 230 may facilitate an improve passage of thermal energy and other environmental conditions from the chamber 122 into the cavity 137, such that the conditions may be more readily and accurately detected by the environmental control systems 300. Furthermore, in some embodiments, a thermally conductive material may be deposited into the through holes 230 and in contact with a least an upper portion of the environmental control systems 300. Example, conductive materials include, but are not limited to, copper, aluminum, silver, gold, carbon, iron, or an alloy including at least one of copper, aluminum, silver, gold, carbon, or iron.

In another embodiment, alone or in combination, the storage system 100 may comprise a plate 260 positioned between and in contact with an upper portion of the environmental control systems 300 and the cap 200, as shown in FIG. 2. The plate 260 may comprise a thermally conductive material, such as but not limited to, copper, aluminum, silver, gold, carbon, iron, or an alloy including at least one of copper, aluminum, silver, gold, carbon, or iron. The plate 260 may be configured to further facilitate an improved transfer of thermal energy from the chamber 122, through the cap 200, and into the cavity 137.

The various embodiments described herein may, advantageously, provide for improved thermal coupling between the chamber 122 and cavity 137, while maintaining an aesthetically pleasing appearance and useful removability achieved by the cap 200. Furthermore, improved thermal coupling and reduction in thickness of the cap 200 are beneficial in achieving a thin profile storage system as described herein.

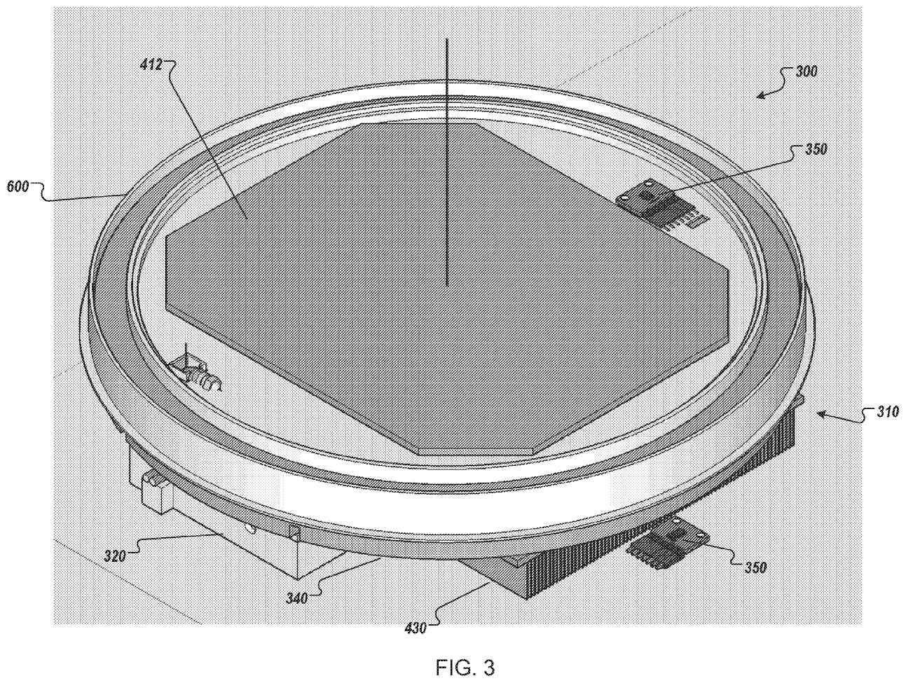

FIG. 3 is a perspective view diagram illustrating example systems for use in embodiments of a storage system according to an embodiment of the present application. For example, FIG. 3 illustrates an environmental control system 300 that may be included within the cavity 137 of FIGS. 1A-1C. As described above, the environmental control system 300 may comprise a control circuitry 330 communicatively coupled to one or more sensors 350, and the control circuitry 330 may be configured to receive outputs from the sensors and automatically adjust the conditions of the environment within the chamber 122 based, at least in part, on the outputs from the sensors.

In the illustrated embodiment, the environmental control system 300 comprises a temperature control system 310, a humidity control system 320, a collection element 600, and a thermal insulator 340. The environmental control system 300 may also comprise one or more power management units configured to receive control signals from the control circuitry 330 and supply electrical power, voltage, and/or current to the temperature control system 310 and/or humidity control system 320. The various sub-systems of the environmental control system 300 are configured to control the temperature within the chamber 122 while also maintaining the humidity for optimized storage conditions, controlling the humidity within the chamber 122 while minimizing the growth of microorganisms, and dissipating thermal energy and observability factors (e.g., acoustic energy due to operation of the system, output of heat into the surrounding environment, reduce unwanted smells, etc.) in stealthy and low profile fashion.

The temperature control system may be configured to adjust a temperature of the environment within the chamber 122, based in part, on a target temperature range associated with the perishable object. The temperature control system 310 may comprise a thermally conductive plate 412 and one or more heat pumps (not shown). The thermally conductive plate 412 may be configured to thermally couple the heat pumps of the temperature control system 310 to the chamber 122. Embodiments of the temperature control system 310 are described in greater detail herein with reference to FIGS. 4A-5C.

The thermal insulator 340 may be deposed between the thermally conductive plate 412 and the one or more heat pumps of the temperature control system 310 to thermally isolate the environment in the chamber 122 from temperature fluctuations within the temperature control system 310 during operation. The thermal isolator 340 may comprise any material having a low thermal conductivity and that is un-responsive or minimally responsive to thermal energy. For example, but not limited to, fiberglass, mineral wood, cellulose, polyurethane foam, polystyrene, air or gas bubbles enclosed in plastic, or the like, and more preferably, extruded polystyrene (XPS) and/or expanded polystyrene (EPS).

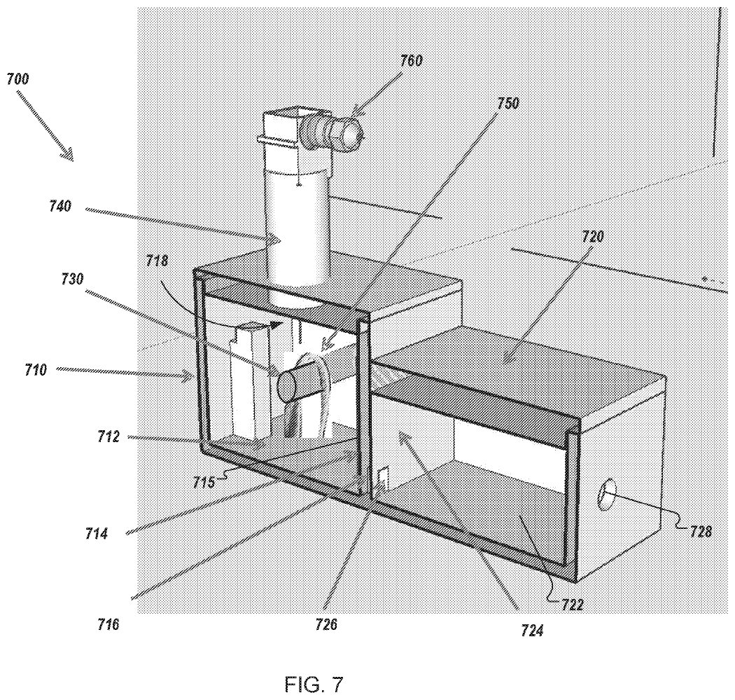

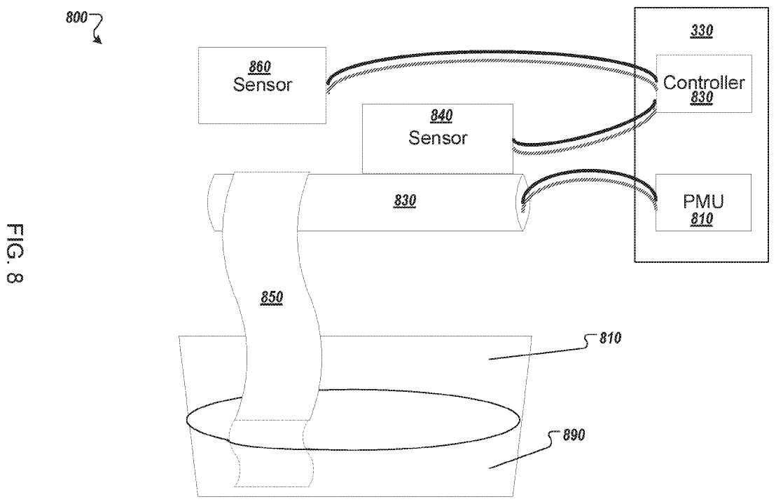

The humidity control system is configured to adjust a humidity of the environment within the chamber 122, based in part, on a target humidity range associated with the perishable object. For example, the humidity control system 320 may generate vapor that can be passed into the environment via a channel connecting the humidity control system 320 to the environment. Embodiments of the humidity control system 310 are described in greater detail herein with reference to FIGS. 7 and 8.

The collection element 600, described in more detail herein, may be arranged to receive condensation from the temperature control system 310, for example, as part of a humidity reduction operation (e.g., FIGS. 9-13).

While the foregoing description is made with reference to environmental control systems 300 disposed within the cavity 137 of storage system 100, it will be appreciated that other configurations are possible. For example, one or more components or any of components of the environmental control system 300 may be located external to the storage system 100 and communicatively coupled to the storage system 100 so to remotely regulate the environmental conditions. Furthermore, the contents of the cavity 137 are not to be limited to those features described herein, other electrical and/or mechanical features not expressly described herein may be included within the storage system 100 without departing from the scope of the present application.

FIGS. 4A-4C are various view diagrams illustrating a temperature control system 400 according to an embodiment of the present application. FIG. 4A is an exploded perspective view diagram illustrating the temperature control system 400 including the thermal insulator 340, collection element 600 and humidity control system 320. FIG. 4B is a perspective view diagram of the temperature control system 400 omitting the thermal isolator 340, collection element 600, and the humidity control system 320. FIG. 4C is a side view diagram of t the temperature control system 400 as shown in FIG. 4B.

Embodiments of the temperature control system 400 are configured to ensure effective and efficient cooling of an environment while minimizing the condensation of vapor. Vapor in an environment will condense from gas to liquid when the temperature of the atmosphere cools to the dew point temperature (sometimes referred to herein as “condensation inducing temperature”). Condensation may occur in a distributed case when a temperature of the environment lowers to the condensation inducing temperature due to uniform cooling by a large heat exchanger. Condensation also may occur in a local case when the temperature of a portion of the environment reaches the condensation inducing temperature due to local cooling by a small heat exchanger. Embodiments herein control the temperature differential between the environment and a heat exchanger to be small, avoiding the removal of humidity from the atmosphere.

In the illustrated embodiment, the temperature control system 400 comprises one or more heat pumps 420 and a first heat exchanger 410 thermally coupled to the environment, for example, within chamber 122. At least a part of the first heat exchanger 410 may be positioned apart from the one or more heat pumps 420 by the thermal insulator 340 and thermally coupled to the one or more heat pumps 420 via corresponding conduits 345 extending through the thermal insulator 340. In some embodiments, the first heat exchanger 410 may be positioned below the cap 200.

The first heat exchanger 410 may comprise a thermally conductive plate 412 positioned in an upper portion of the temperature control system 400. The thermally conductive plate 412 may be thermally coupled to the environment and configured to transfer heat from the environment to the one or more heat pumps 420, for example, when cooling down the environment. Alternatively, the thermally conductive plate 412 may transfer heat from the one or more heat pumps 420 to the environment to increase the temperature therein. The thermally conductive plate 412 may comprise a material of at least one of copper, aluminum, silver, gold, carbon, iron, or an alloy including at least one of copper, aluminum, silver, gold, carbon, or iron.

In certain embodiment, only an upper portion of the heat exchanger 410 may be exposed to the environment of the chamber 122. Such a configuration may prevent inadvertent flow of thermal energy back to the environment from the one or more heat pumps 420 due in part to the distance between upper portion and the heat pumps. Thus, an increased distance between the upper portion of the heat exchanger 410 and the heat pumps may provide for improved energy usage and temperature control. Furthermore, this separation permits the installation of the thermal insulator 340. Accordingly, embodiments herein balance advantageous provided by increased distance with a preference for a reduced system profile.

In some embodiments, the thermally conductive plate 412 may be positioned between the one or more heat pumps 420 and the perishable object. For example, the thermally conductive plate 412 may be in contact with the environment and/or the perishable object 190 (e.g., where a cap 200 is omitted). In embodiments that omit the cap 200, the perishable object may be positioned on a top surface of the thermally conductive plate 412, which may be approximately 80 mm or less from the base 133 of the housing 130 along the axis 101, preferably approximately 60 mm or less, and/or more preferably approximately 40 mm or less. In another embodiment, the thermally conductive plate 412 may be in contact with the cap 200. In some embodiments, the thermally conductive plate 412 may comprise a planar surface that is substantially parallel to the plane established by the one or more heat pumps 420, which may be parallel to the top surface of, for example, the cap 200.

The one or more heat pumps 420 may be any mechanical heat pump or electrical heat pump that may be driven, for example, by an electrical power source, current source, or voltage source to influence the temperature of its surroundings. For example, in one embodiment, the one or more heat pumps may be thermoelectric heat pump driven by an electrical power source, current source, or voltage source to induce a temperature difference between a first and second side. In various embodiments, the one or more heat pumps 420 may comprise at least one heat pump configured to influence the temperature in the environment based on at least one of a Peltier Effect (e.g., a Peltier thermoelectric device) or a Carnot Cycle (e.g., a heat engine).

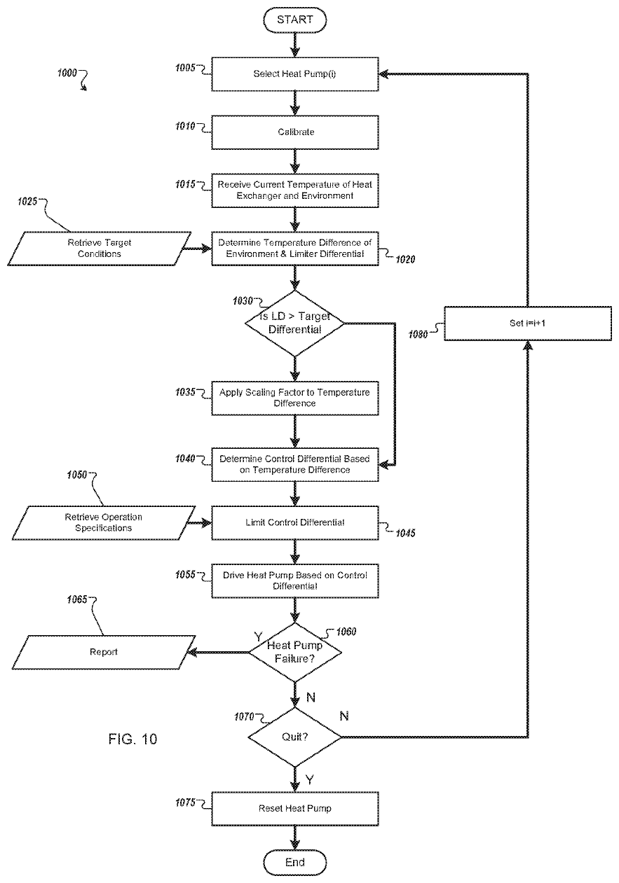

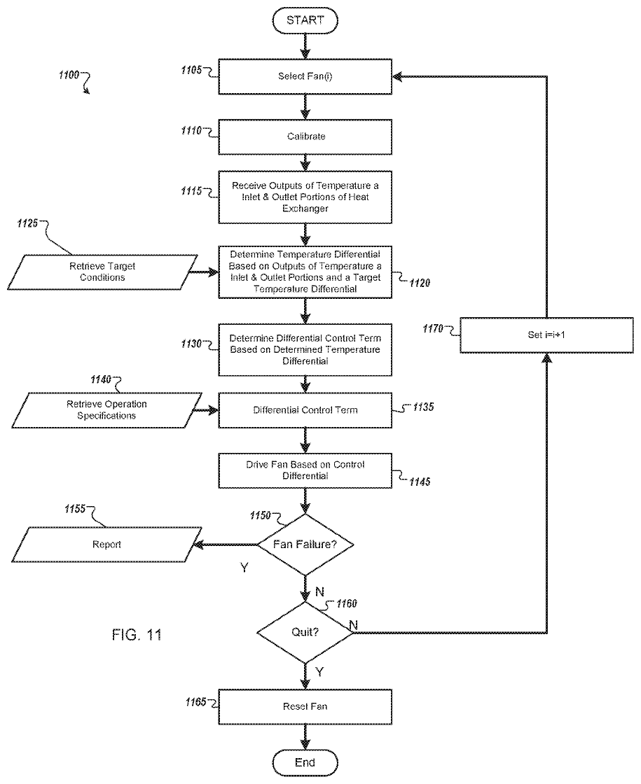

In embodiments comprising a thermoelectric heat pump, each heat pump 420 may comprise a first side and second side opposite the first side, and the first side may draw heat from or transfer heat to the environment in the chamber 122 in response to supplied electrical power. For example, the first side of the heat pump may be coupled to the thermally conductive plate 412 via the corresponding conductor 415 to draw and/or transfer thermal energy into and/or out of the chamber 122. The second side may be disposed on the second heat exchanger 430, such that the temperature across the second side is maintained at ambient temperature within a target temperature differential (e.g., process 1100 of FIG. 11). In operation (e.g., according to process 1000 of FIG. 10), electrical power may be supplied to the heat pump 420 by a power management unit included in the control circuitry 330 to cause the first side to operate as a cold side and draw heat from the chamber. Alternatively, heat pump 420 may be supplied electrical power to cause the first side to operate as a hot side and transfer heat to the chamber 122.

In various embodiments, the one or more heat pumps may comprise a plurality of heat pumps. In some embodiments, each heat pump of the plurality of heat pumps are individually coupled to the electrical power source and driven based on corresponding control signals to each heat pump. In another embodiment, the plurality of heat pumps may be connected in parallel or serially to the electrical power source and driven based on a common control. For example, FIGS. 4A-4C illustrates four heat pumps 420 arranged in a two by two configuration. However, this is for illustrative purposes only, and other configurations and quantities of heat pumps are possible. For example, any array of N heat pumps×M heat pumps may be possible where N and M need not be the same integer of heat pumps, a linear configuration of heat pumps (e.g., 1×M heat pumps or M×1 heat pumps), etc. Furthermore, the one or more heat pumps need not be arranged in an ordered configuration, but may be in any planar configuration, such as for example, a “T” shaped configuration where one or more heat pumps occupy the “|” of the “T” while two or more heat pumps occupy the “^{—}” of the “T.” Other configurations are possible, for example, rectangular, circular, semi-circular, a portion of a circle, ovular, etc.

FIGS. 4A-4C also depict illustrative examples of a wiring 405 that may be connected to a power management unit in the environmental control system 300 and used for supplying electrical power, voltage, and/or power to the one or more heat pumps 420. The wirings 405 may electrically couple the one or more heat pumps to an internal or external power source. In the illustrative embodiments, wirings 405 may comprise two wirings for supplying electrical power in accordance with control signals received from the controller circuitry.

In the illustrated embodiment, the temperature control system 400 may also include one or more thermal conductors 415 corresponding to each heat pump 420. The one or more thermal conductors 415 may extend from the thermally conductive plate 412 to a corresponding heat pump 420 via a corresponding conduit 345 through the thermal insulator 340 (e.g., as illustrated by dotted line 401). Similarly, where a collection plate 600 is included, the thermal conductors 415 may extend through a conduit 645 as shown in FIG. 4A. In some embodiments, the thermally conductive plate 412 may be attached to or fasten to each of the plurality of thermal conductors 415 (e.g., via welding, adhesive, soldering, brazing, riveting, bonding, melting, etc.). In some embodiments, a thermal conductive layer (not shown) may be disposed between the thermally conductive plate 412 and the plurality of thermal conductors 415. In yet another embodiment, the thermally conductive plate 412 and the plurality of thermal conductors 415 may be formed from a single piece of material. The thermal conductors 415 may comprise a material of at least one of copper, aluminum, silver, gold, carbon, iron, or an alloy including at least one of copper, aluminum, silver, gold, carbon, or iron.

Embodiments herein may be arranged so to define a location for localized and controlled condensation. For example, by stacking the first heat exchanger 410 on top of the heat pumps 420 as illustrated, the location of condensation may be advantageously delineated. While cooling the environment, heat energy may flow towards the heat pumps 420 reducing temperatures of components lower in the cavity 137 relative to the components higher with in the cavity 137. When the thermally conductive plate 412 is exposed to the environment, condensation may occur on a bottom surface of the thermally conductive plate 412 near the thermal conductors 415. The storage system may then collect the condensation via the collection element 600. Managing the location of condensation through structural configurations as described herein may avoid undesirable effects including, but not limited to, damaging sensitive electronic components, pools of liquid where bacteria flourishes, obscuration of transparent surfaces, and the loss of the liquid which could be reused in the humidity control system 320.

Returning to FIGS. 4A-4C, the one or more heat pumps 420 may be disposed on a surface 432 of a second heat exchanger 430, positioned on a side of the heat pumps 420 opposite the first heat exchanger 410. The second heat exchanger 430 may comprise a heat sink having the surface 432 and a plurality of fins 435 extending from the surface 432 away from the heat pumps 420. For example, the plurality of fins 435 may extend from the one or more heat pumps 420 toward the base 133 of the housing 130 of storage system 100. The plurality of fins 435 may be aligned in a first direction (e.g., illustrated as arrow 431) that is substantially parallel to a plane defined by surface 432 of the second heat exchanger 430.

The effectiveness of a heat exchanger, such as heat exchanger 430, increases when fluid flow over the heat exchanger is orderly, unidirectional and free of turbulence. Thus, fluid flow through the heat exchanger is preferably transversally and along the surface area of the fins with minimal fluid impedance (e.g., laminar), thereby experiencing few changes in direction and speed. Back-flow, where fluid flow of differing speeds or differing temperatures are unintentionally mixed should be avoided. However, conventional systems utilize a brute force methodology that attempts to blasts the heat sink with cooling airflow from a direction perpendicular the direction in which the fins are aligned. This approach may cause turbulence between the fins that reduces the effectiveness of the heat exchanger.

For example, conventional systems typically direct fluid flow at the heat exchanger versus across the heat exchanger (as described herein). These approaches fail to establish a fluid flow across the heat exchanger that is orderly, unidirectional and free of turbulence. After the fluid flow impacts the heat exchanger of the conventional systems the flow escapes using disorderly and multidirectional paths. Thus, the fluid flow escaping a heat exchanger configured as in the conventional systems is not managed and back-flow to the inlet of the fan is possible.

Whereas embodiments herein provide for fluid flow that is across the heat exchanger 430 such that it is possible to direct the fluid flow to an outlet position and minimize or eliminate back-flow. For example, embodiments herein provide an improved temperature control system that may ensure fluid flow enters the heat exchanger 430 at an inlet position 433, transfers heat energy with the heat exchanger 430, and then exits the heat exchanger 430 with minimal turbulence out an outlet position 437. Thus, in several embodiments described herein, the temperature control system 400 may also comprise at least one transversally mounted fan, for example, at least one fan 440 arranged to generate a fluid flow across a surface area of the plurality of fins. The at least one fan 440 may be configured to draw fluid external to the storage system 100 through an opening 132 (e.g., an inlet opening), generate the fluid flow from the inlet position 433 to the outlet position 437, and expel the fluid through a second opening 132 (e.g., an outlet opening).

In various embodiments, the at least one fan 440 may positioned a first side (e.g., aligned with an inlet position 433) of the second heat exchanger 430 and, when operating, cause the fluid to flow from the first side of the heat exchanger 430 to a second side (e.g., aligned with an outlet position 437) of the heat exchanger 430 across a surface area of the plurality of aligned fins 435. In one embodiment, the first side of and the second side of the heat exchanger 430 are on opposite sides of the heat exchanger 430 along the first direction 431. In another embodiment, the first side and the second side of the heat exchanger 430 are on different sides of the heat exchanger, for example, sides that are perpendicularly orientated. In this embodiment, the plurality of fins 435 may be similarly bent such that the fluid flow is across the surface are of the plurality of fins 435. In another embodiment, the first side and the second side of the heat exchanger 435 may be on a common side of the heat exchanger 430 (e.g., inlet and outlet of fluid flow is from the same side of the heat exchanger 430).

FIG. 4A-4C also illustrates an optional fluid guidance element 436 configured to guide fluid flow from the at least one fan 440 into the second heat exchanger 430. The angle and placement of the fluid guidance element is selected to reduce turbulence and fluid impedance. For example, the at least one fan 440 may have a height greater than inlet position 433 of the heat exchanger 430, thus fluid flow generated by the fan 440 may include a portion of fluid that would not be directed into the heat exchanger 430. This may result in unwanted turbulence at as fluid passes into the heat exchanger. Thus, the fluid guidance element 436 may be configured to direct fluid flow from a height above inlet position 433 of the heat exchanger 430 into the heat exchanger 430 so to pass flow across the surface area of the fins 435.

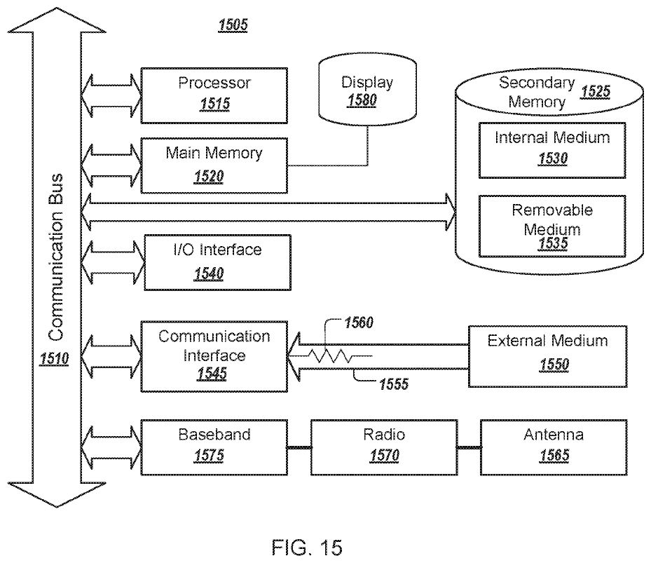

The temperature control system 400 also comprises one or more temperature sensors communicatively coupled to a control circuity 330 (e.g., implemented as a process system 1505 of FIG. 15). FIGS. 4A-4C illustrate four sensors 460-466, one or more of which may be a temperature sensor. For example, one of sensors 460 and/or 462 may be disposed between the heat pumps 420 and thermally conductive plate 412. Specifically, as illustrated the sensors 460 and 462 may be positioned on the collection element 600. One or more of sensors 460 and/or 462 may be configured as a temperature sensor that reads the temperature of the environment within the chamber 122 and outputs a signal indicative of the current temperature in the environment to the controller circuitry. In an embodiment, sensor 462 may be configured as a temperature sensor that reads the temperature of the first heat exchanger 410 and outputs a signal indicative of the current temperature of the first heat exchanger 410, while sensor 460 reads the temperature of the environment. In some embodiment, sensor 462 may be in direct contact with the thermal conductive plate 412 and configured to output a signal indicative of the current temperature of the thermally conductive plate 412. These output signals may be utilized to automatically adjust the temperature of the environment based, at least in part, driving the one or more heat pumps 420 in accordance with the processes herein (e.g., as described in connection to FIGS. 9-13).

In some implementations, one of sensors 464 and/or 466 may be disposed at the inlet and outlet positions 433, 437 of the second heat exchanger 430. For example, as illustrated in FIG. 4C, the sensor 464 is disposed at the inlet position between the fan 440 and the heat exchanger 430, while the sensor 466 is disposed at the outlet position 437. The sensors 464 and 466 may be temperature sensors configured to read the temperature at the respective positions and outputs a signal indicative of the respective temperatures to the controller circuitry. The controller circuitry may then determine a temperature differential between the inlet and outlet positions 433, 437 of the heat exchanger 430. These output signals may be utilized to automatically drive the at least one fan 440 to maintain a target temperature differential at the heat exchanger 430 in accordance with the processes herein (e.g., as described in connection to FIGS. 9-13).

While embodiments herein are described with reference to an example configuration where the thermally conductive plate 412 is positioned apart from the one or more heat pumps 420 by the thermal insulator 340. Other configurations are possible without departing form the scope of the present disclosure. For example, certain embodiments may swap the position of the one or more heat pumps 420 with the thermal conductors 415, for example, as shown in FIGS. 4D and 4E. As illustrated in FIG. 4D, the one or more heat pumps 420 may be disposed and/or in contact (direct or indirect) with a bottom surface of the thermally conductive plate 412, and thermal conductors 416 may extend from the corresponding one or more heat pumps 420 to the second heat exchanger 430. FIG. 4D omits the thermally conductive plate 412 for illustrative purposes only. In some embodiments, the one or more heat pumps 420 may be positioned between thermal conductors 415 and 416, and the thermally conductive plate 412 and heat exchanger 430 may be coupled to the thermal conductor 415 and 416, respectively, as shown in FIG. 4E. Further still, each of the one or more heat pumps 420 need not be positioned along the same plane as illustrated in FIGS. 4A-4E. For example, each of the heat pumps 420 may be positioned at differing respective distances along the height axis (e.g., axis 101) apart from either the heat exchanger 430 and/or thermally conductive plate 412. As another example, a first one or more heat pumps 420 may be positioned as shown in FIGS. 4A-4C, a second one or more heat pumps 420 may be positioned as shown in FIG. 4D, and/or a third one or more heat pumps 420 may be positioned as shown in FIG. 4E, or any combination thereof.

FIGS. 5A-5C are various view diagrams illustrating another example temperature control system 500 according to an embodiment of the present application. FIG. 5A is an exploded perspective view diagram illustrating the temperature control system 500 according to an embodiment of the present application; FIG. 5B is a perspective view diagram of the temperature control system 500 according to an embodiment of the present application. FIG. 5C is a side view diagram of the temperature control system take along a cross section B-B of FIG. 5B according to an embodiment of the present application.

The temperature control system 500 may be substantially similar to the temperature control system 400. For example, the temperature control system 500 comprises a first heat exchanger 410 including a thermally conductive plate 412 coupled to one or more heat pumps 420. The thermally conductive plate 412 may be positioned apart from the one or more heat pumps 420 by the thermal insulator 340 via corresponding conduits 345 extending through the thermal insulator 340. The temperature control system 500 may also comprise thermal conductors 415 that extend from the thermally conductive plate 412 to a corresponding heat pump 420 via a corresponding conduit 345. As depicted in FIG. 5B (and described above), the thermal conductors 415 may be formed of separate pieces of material and attached to the thermally conductive plate 412 (or they may be a single piece of material). Accordingly, the temperature control system 500 may function in a manner substantially similar to temperature control system 400 and provide substantially the same benefits.

Temperature control system 500 further comprises a second and a third heat exchanger 530A, 530B, respectively, and at least one fan 440 positioned there between at region 538, for example, a middle region in this embodiment. The second and third heat exchangers 530A and 530B may be substantially similar to heat exchanger 430, except that the at least one fan 440 generates a fluid flow by pulling fluid in from the inlet position 533A and through the second heat exchanger 530A to an intermediate position 537A. The fluid flow may then be expelled through the third heat exchanger 530B by passing fluid from into an intermediate position 533B and out the outlet position 537B. Accordingly, the second and third heat exchangers 530A and 530B and at least one fan 440 may function in a manner substantially similar to second heat exchanger 430 and provide substantially the same benefits.

FIGS. 5A-5C also illustrates an optional fluid guidance element 536 configured to guide fluid flow from the second heat exchanger 530A to the at least one fan 440 and then from the at least one fan 440 into the third heat exchanger 530B. As described above, the angle and placement of the fluid guidance element 536 is selected to reduce turbulence and fluid impedance. For example, the at least one fan 440 may have a height greater than the heat exchanger 430. In such an embodiment, the fluid guidance element 536 may comprise an angled surface 510 to direct the flow from the fins 535A of the second heat exchanger 530A to fill the surface area of the at least one fan 440. The angle of surface 510 may be based on an angle established by connecting the surface 532A to the top of the fan 440. Similarly, but on the opposite side of the fan 440, the fluid guidance element 536 may comprise an angled surface 511 to direct flow from a height above the third heat exchanger 530B into fins 535B of the third heat exchanger 5306.

In the illustrated embodiment, fluid guidance element 536 may encompass the fan 440 via side walls 512-515. Side walls 512-515 may be configured similar to angled surfaces 510 and 511 to direct fluid flow that otherwise is outside of heat exchangers 530A and 530B. In other embodiments, the fluid guidance element 536 need not encompass the fans 440.

While examples are illustratively provided in FIGS. 4A-5C, it will be appreciated that other configurations are possible. For example, FIGS. 5A-5C illustrate the at least one fan 440 positioned at approximately the middle region 538asdf of the temperature control system 500. However, this need not be the case, and the fan may be positioned anywhere base on the positioning of the heat exchangers. Furthermore, the temperature control system may comprise multiple fans positioned at multiple locations to facilitate fluid flow, for example, a first fan in the middle, a second fan at an inlet, and/or a third fan at the outlet. Other configurations are possible. Further still, any number of heat exchangers may be provided, and need not be limited to one or two heat exchanges. For example, 3, 4, 5, etc.

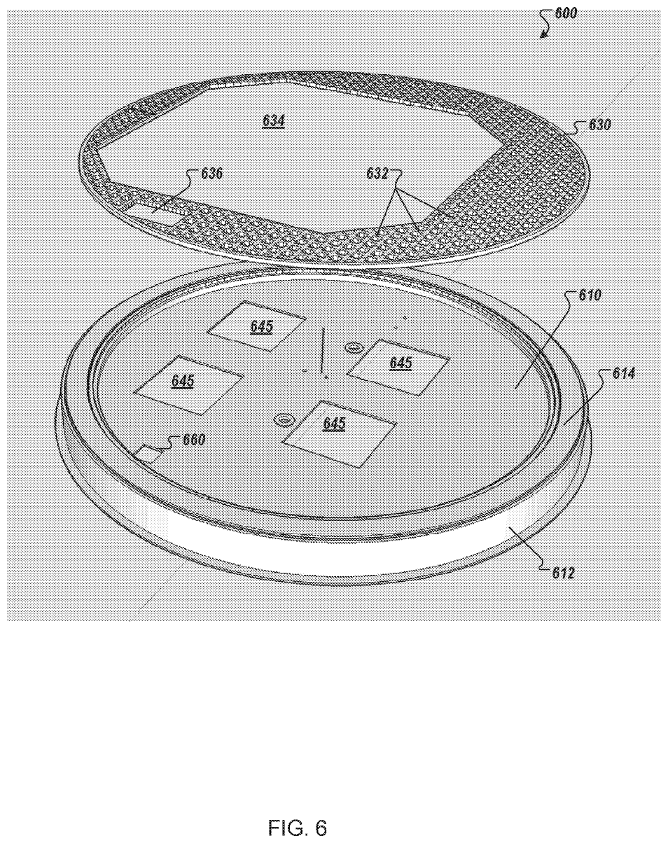

Condensation of fluid vapor within the environment may occur along any surface of the storage system 100, where the temperature at a surface is equal to or below a condensation inducing temperature (e.g., a dew point). FIG. 6 is a perspective view diagram illustrating embodiment of a collection element 600 that may be included in the storage systems described herein and arranged to receive condensation.

In various embodiments, the collection element 600 may be positioned between an upper portion and a lower portion of the temperature control system 310. The collection element 600 may comprise a recessed region 610 and a lip 614 positioned at a height above the recessed region 610 and between the recessed region 610 and a side wall 612. The recessed region 610 may be configured as such to receive condensed fluid and contain the fluid within the collection element 600 surrounded by the lip 614. In some embodiments, fluid is unable to pass into the cavity 137 at least because the conduits 645 and channel 660 comprise the thermal conductors 415 and a nozzle 760 of FIG. 7. Thus, condensed fluid is contained and held by the collection element 600. In some embodiments, the fluid is contained until it vaporizes. In some embodiments, vaporization may be induced, for example, by controlling the temperature of the environment. In another embodiment, alone or in combination, channel 650 or another channel may permit fluid to pass from the recessed region 610 into the humidity control system 320.

The collection element 600 may also comprise an optional mesh element 630. The mesh element 630 may comprise a plurality of containment regions 632 each configured to receive and contain condensed fluid. The mesh element 630 comprises a channel 636 corresponding to channel 650 and an opening 634 arranged to receive the thermally conductive element.

FIG. 7 is a cross-section perspective view diagram illustrating a humidity control system 700 taken along a cross section C-C shown in FIG. 5A according to an embodiment of the present application. The humidity control system 700 may be an example implementation of the humidity control system 320 described herein. In various embodiments, the humidity control system 700 may be configured to maintain or regulate a humidity level in the environment (e.g., within chamber 122 of FIGS. 1A-1C) by the addition or removal of liquid vapor from the environment. For example, liquid vapor may be added, thereby increasing the humidity level, by heating the liquid to a boiling or evaporation temperature. Whereas, reducing humidity may be achieved by removing liquid vapor by inducing condensation on surfaces of the storage system 100 and collecting condensation from the environment.

Embodiments of humidity control systems described herein provide for effective and efficient control of humidity within an environment (e.g., within chamber 122 of the storage system 100) while minimizing the growth of microorganisms. The amount of liquid needed to control the humidity for a given volume of atmosphere while maintain low growth of microorganisms is very small. For example, where the liquid is water and the environment comprises approximately 800 liters of air at 15° C., increasing the relative humidity from 85% to 95% may require boiling approximately 1 ml of water. However, conventional humidity control systems implement a course methodology to change humidity levels by boiling all liquid contained in a reservoir to make any change in humidity level (large or small). These systems fail to modify the amount of liquid boiled based on the desired change in humidity, thus are inefficient and wasteful. According, systems herein conserve energy and liquid be determining an amount of liquid required to induce the sought change in humidity levels.

While the following description is made with reference to the storage system 100 of FIGS. 1A-1C, it will be understood that the humidity control system 700 is not so limited and may be implemented individually without the temperature control system, may be implemented in other systems besides the example embodiments herein, and/or may be implemented as a standalone system.

In the illustrated embodiment of FIG. 7, the humidity control system 700 comprises a first chamber 710 arranged to receive liquid via a first opening 716. The first chamber may comprise a bottom surface 712 and a first partition wall 714. The first opening may be positioned along the first partition wall 714 at the bottom surface 712. The first chamber 710 may also comprise a hole 718 leading to a channel 740 through which vapor may pass from the first chamber 710 to exit the first chamber 710, for example in one embodiment, into the environment within the chamber 122 of FIGS. 1A-1C.

The humidity control system 700 may also comprise a second chamber 720 having a second partition wall 724 and a second opening 726. The second opening 726 may be positioned along the first partition wall 724 at a bottom surface 722 of the second chamber 720. The second chamber 720 may comprise a hole 728 through which the second chamber 720 may be arranged to receive liquid from an external source. For example, a user may access the humidity control system by removing the lid 120 and, if present, the perishable object 190 and cap 200, to add a liquid to the first chamber. The hole 728 may be connected to a hose or may accept water directly from a faucet. In some embodiments, hole 728 may be replaced with a lid (not shown) removably attached to the second chamber 720.

The first and second chambers 710, 720 may be in fluid communication via the first and second openings 716, 726, such that the first chamber 710 may receive liquid from the second chamber 720. In some embodiments, the first and second partition walls 714, 724 are a commonly shared partition wall between the first and second chambers 710, 720. In another embodiment, the first and second chambers 710, 720 may be separated within the storage system 100 and in fluid communication via a hose or other connection between the first and second openings 716, 726. The first and second openings 716, 726 need not be square as illustrated, and may be any shape desired to permit fluid communication.

The humidity control system 700 also comprises a heating element 730 and an article 750. The article 750 may be configured to use capillary action to bring a portion of the liquid held in the first chamber 710 into contact with the heating element 730. The heating element 730 may be configured to heat the least a portion of the liquid to a first temperature to generate vapor. The first temperature may be, for example, a boiling temperature associated with the liquid (e.g., 100° C. for water). The amount of liquid drawn to the heating element 730 may be based, in part, on a target humidity level associated with the perishable object. For example, a target humidity level may be 80% for Manchego cheese, but other levels may be possible. The heated liquid is evaporated and the resulting vapor may pass through the opening 718 into the channel 740 and exit into the chamber 122.

The heating element 730 may be positioned within the first chamber 710 above the bottom surface 712. Preferably, the heating element is disposed above the first opening 716, and more specifically, above a top area 715 of the first opening 716. Thus, the humidity control system 700 may operate when in a filled state, e.g., the first chamber 710 comprise liquid at a height above the top area 715. Accordingly, during operation, vapor generated in the first chamber 710 will not be able to pass into second chamber 720 via the second opening 716. Furthermore, the humidity control system may not operate (e.g., turned off) when the liquid is below the top area 715 and/or if the level of the liquid held in the first chamber is equal to or above any portion of the heating element 730. Thus, the held liquid is apart from and not in contact with the heating element 730, and only liquid drawn into contact with the heating element 730 is heated to the first temperature.

The article 750 may be configured to use capillary action to bring a portion of the liquid held in the second chamber 710 into contact with the heating element 730. For example, the article 750 may be engaged with the heating element 730 and extend toward the bottom surface 712 of the first chamber 710. When liquid is present within the first chamber 710 the article 750 may extend into and contact the liquid. Thus, conduit may be arranged to draw liquid held in the first chamber 710 toward the heating element 730 via capillary action. In various embodiments, the article 750 may be in direct contact with the heating element 730, and thus only liquid in contact with the heating element 730 need be heated to the first temperature.

In some embodiments, the heating element 730 may comprise an electrical circuit comprising a resistive element enclosure configured to convert electrical energy into heat based on control signals from, for example, the control circuitry. The heating element 730 may comprise any heating device, for example, metal based heating elements, ceramic based heating elements, polymer heating elements, composites, or the like. In some implementations, ceramic heating elements due antimicrobial properties that may minimize the growth of bacteria. Metal heating element embodiments may comprise, copper, aluminum, silver, gold, carbon, iron, or an alloy including at least one of copper, aluminum, silver, gold, carbon, or iron. For example, a heating element comprising a resistive element enclosure including a resistive wire surrounded by an electrically insulated layer with an outer enclosure. The wire may be any resistive material, including but not limited to, nickel and/or chromium or metal alloys comprising at least one of nickel and/or chromium. The insulated layer may comprise, for example, magnesium oxide or the like. The outer enclosure may comprise one or more of, steel, copper, brass or the like. Copper may be advantageous due to temperature stability to avoid overheating and improved control as well as antimicrobial properties that may minimize the growth of bacteria.

In some embodiments, the article 750 may comprise a wick, for example, a solder wick, candle wick or the like. Example candle wicks may comprise a porous material configured to absorb at least some of the liquid in the first chamber. In some implementations, the article 750 may comprise braided cotton, however other porous materials may be used. Example wicks comprise a metal braid, for example, copper, for example, due antimicrobial properties that may minimize the growth of bacteria.

In some embodiments of the humidity control system 700 may be configured to reduce microorganism spread throughout the atmosphere that may result based on increasing humidity levels. Microorganisms and their spores may be disinfected with the application of heat. For example, raising the temperature of contaminated liquid water to 80° C. may kill live Legionella bacteria, and raising the temperature further to 116° C. may kill bacteria spores. However, conventional humidifier systems do not address these bacteria concerns. For example, conventional systems simply raise the temperature of water to 100° C. to cause the water to boil and convert to gas. The resulting contents are simultaneously in liquid and gaseous states and as such, the temperature of the contents is no greater than the boiling temperature (100° C.), which is not high enough to kill bacteria spores. Since bacteria may remain present in the contents of conventional systems, they would be less than ideal for certain application where a perishable object is a consumable item.

According, embodiments herein advantageously provide for low bacteria growth opportunities. For example, as part of the vapor generating process, the heating element 730 may be heated to temperature greater than necessary to kill microorganisms. For example, where the liquid is water, the heating element 730 can heated the liquid to 100° C. which is high enough to kill some bacteria, e.g., live Legionella bacteria. Alternatively or in combination, the heating element 730 may be heat the vapor to a second temperature above the first temperature (e.g., 100° C.) to kill other bacteria (e.g., 116° C. to kill spores). However, in some implementations, this may be less efficient as heating the heating element 730 above the first temperature, beyond necessary for generating vapor, may require more power than necessary.

Thus, in some embodiments, the humidity control system 700 may comprise a nozzle 760 positioned at an end of the channel 740 proximal the environment. The nozzle 760 may be heated to the second temperature above the first temperature to increase the temperature of the vapor passing through the channel 740. Thus, the vapor entering the environment may be superheated to the second temperature thereby reducing the presence of bacteria and other microorganisms in the environment. In some embodiments, the second temperature may be selected based on a temperature known to kill specifically targeted bacteria and/or microorganisms. Example pathogenic microorganisms may include Salmonella, Norovirus, Norwalk Virus, Campylobacter, E. coli, Listeria, Clostridium perfringens, Clostridium Botulinum, Legionella Pneumophila, etc. In some embodiments, the second temperature may be approximately 10° C. or more above the first temperature, or more preferably approximately 20° C. or more. For example, in some embodiments, the second temperature may be approximately 116° C. or more or approximately 120° C. or more, where the first temperature is 100° C.

In some embodiments, the heating element 730 may be thermally coupled to the nozzle 760 and to the channel 740. The temperature of the heating element 730, and thus the channel 740 and nozzle 760, may be heated to the second temperature. The heating element 730 may raise the temperature of the liquid in contact with the heating element 730 to the first temperature, causing the liquid to vaporize at the first temperature. Due to a volumetric expansion when the liquid changes state to gas there may be a buildup of vapor pressure in the first chamber 710 which forces the vapor through the channel 740 and nozzle 760. In some implementations, an internal dimension of the channel 740 and nozzle 760 may be relatedly small (e.g., equal to or less than approximately 1 mm along a cross section) and the vapor is heated to the second temperature as it passes through the channel 740 and nozzle 760.

FIG. 8 is a schematic diagram illustrating another humidity control system 800 according to an embodiment of the present application. The humidity control system 800 may be substantially similar to the humidity control system 700 described above.

For example, the humidity control system 800 comprises a first chamber 810 which may act as a reservoir to hold liquid 890, an article 850, and a heating element 830. The first chamber 810 may be similar to the first chamber 710, and may receive liquid via an opening (not shown). The heating element 830 and article 850 may be substantially similar to the heating element 730 and article 750, respectively. Accordingly, article 750 may draw a portion of liquid 890 to heating element 830, which may heat the portion of liquid to a first temperature to generate vapor.

In the illustrated embodiment, the humidity control system 800 further comprises a control circuitry 830 and sensors 860 and 840. The sensor 840 may be a humidity sensor disposed within the environment of the chamber 122 that reads the humidity within the chamber 122. For example, sensor 860 may be implemented as one of sensors 460 and/or 462 of FIGS. 4A-5C. Sensor 840 may be thermally coupled to the heating element 830 and configured to detect a temperature of the heating element 830 and output a signal indicative of the temperature.

In some embodiments, the control circuitry 830 may be similar to control circuitry 330 of FIGS. 1A-1C and configured to drive the heating element to adjust a humidity of the environment based on a target humidity range associated with the perishable object. For example, in some implementations, the control circuitry 830 may be communicatively coupled to sensor 860 as a humidity sensor. The sensor 860 may output a signal indicative of the current humidity level in the chamber 122. The output signal may be utilized by the control circuitry 830 to automatically adjust the humidity in the environment based, at least in part, driving the heating element 830 in accordance with the processes herein (e.g., as described in connection to FIGS. 9-13).

For example, the control circuitry 830 may be configured to drive the heating element 830 for a duration of time based on the amount of vapor to be generated. Since the amount of vapor to be generated may be predetermined (e.g., based on a desired increase in humidity), the duration of time can be calculated from an amount of liquid to be vaporized and a rate of vaporization at the first temperature. The amount of liquid to be vaporized may be determined from a rate that the liquid is drawn to the heating element 830 (herein referred to as “rate of capillary action”) and the determined amount of vapor desired. The rate of capillary action may be dependent upon the surface area and size of the article conduit 850. The amount of vapor desired may be determined based on measuring the humidity in the environment with sensor 860. The output from sensor 860 may be indicative of a current humidity level. The amount of vapor desired may be determined based on the difference between the current humidity level and the target humidity level, where the difference corresponds to an amount of vapor to increase the current humidity level to the target humidity level. Thus, the control circuitry 830 may receive the output from sensor 860, determine a duration of time and control the power management unit 810 to supply a voltage to the heating element based on the duration of time.

FIG. 9 is a flow chart illustrating a process 900 for regulating an environment surrounding a perishable object in accordance with various embodiments of the present application. The process 900 may be performed to facilitate effective and efficient control of environmental conditions, for example temperature control while minimizing the condensing of vapor based, in part, on target conditions corresponding to the perishable object. In certain embodiments, the process 900 may be performed by the storage system 100 illustrated in FIGS. 1A-1C discussed above. While, the following description of process 900 is made with reference to storage system 100, the scope is not so limited and may be implemented in any system or device configured to perform the steps described herein.

The process 900 may be started in response to entering an environmental regulating mode of operation. For example, the storage system 100 may be turned on via a user interface, the lid 120 may be engaged with the enclosure body 130 representative of a perishable object being prepared for storage, the user may interact with the interface to press a start button, knob, or interface, the user may set target parameters and/or enter information indicative of the perishable object, etc.

At step 910, target environmental conditions are determined. For example, target environmental conditions may be based on a desired environment of the perishable object. In various embodiments, the target environmental conditions may comprise, but are not limited to, a target temperature and a target humidity of the perishable object contained within the environment (e.g., in chamber 122 of storage system 100).

In some implementations, an input indicative of the perishable object may be received, for example, by a control circuitry 330 (e.g., system 1505 of FIG. 15) the storage system 100. For example, the input may indicate what the perishable object is (e.g., consumable goods or other articles), and the control circuitry may retrieve the target environmental conditions from a database based on the received input. The database may be locally comprised in the storage system 100 and/or control circuitry. Thus, certain desired environments may be pre-stored within the storage system 100, and the user may be able to access the memory to update the stored parameters. In some embodiments, alone or in combination, the database may be remote from the storage device, and the control circuitry may retrieve the target environmental conditions via a wired or wireless connection. The target environmental conditions may be stored in association with a give perishable object and the database may store a plurality of perishable objects. In some embodiments, the target environmental conditions and perishable object may be retrieved from a look-up-table.

At steps 920 and 930 the current environmental conditions are adjusted based on the target conditions to regulate the environment surrounding the perishable object. Regulating the environment may comprise maintaining the environmental conditions at the desired environment or changing the conditions as desired, for example, based on a newly stored perishable object. In certain embodiments, the environmental conditions may be controlled by environmental control systems 300.

At step 920, the temperature of the environment may be adjusted based, in part, on the target temperature. In certain embodiments, a temperature control system (such as temperature control system 310) may be implemented to adjust the temperature based on the target temperature. For example, the current temperature may be adjusted by driving one or more heat pumps 420 to adjust a temperature of the environment based, in part, on a temperature difference between a current temperature of the environment and the target temperature of the perishable object. Thus, the current temperature may be adjusted to approach or otherwise match the target temperature within a target range of deviation. In some embodiments, the target range of deviation may be plus or minus approximately 5° C., and more preferably, plus or minus approximately 2° C. An example implementation of step 920 may be performed using process 1000 and 1100 illustrated below in FIGS. 10 and 11 as sub-processes of process 900.

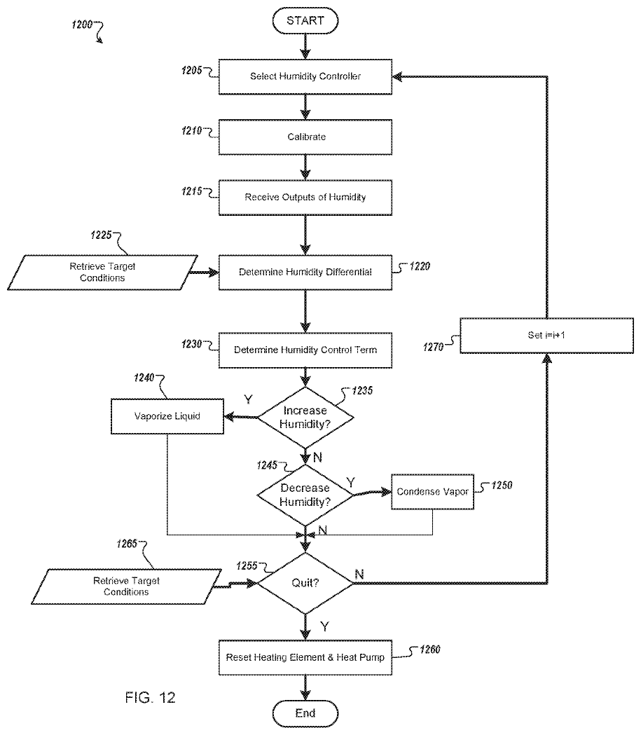

At step 930, the humidity of the environment may be adjusted via vaporizing an amount of liquid. In certain embodiments, a humidity control system (such as humidity control system 320) may be implemented to adjust the humidity based on the target humidity. For example, the current humidity may be adjusted by driving one or more heating elements 730 to adjust a humidity in the environment via vaporizing an amount of liquid based, in part, on a humidity differential between a current humidity in the environment and the target humidity. Thus, the current humidity may be adjusted to approach or otherwise match the target humidity within a target range of deviation. In some embodiments, the target range of deviation may be plus or minus approximately 15%, and more preferably, plus or minus approximately 5%. An example implementation of step 930 may be performed using processes 1200-1400 illustrated below in FIGS. 12-14 as sub-processes of process 900.

At decision step 940, a determination is made whether to end process 900. In certain embodiments, the determination to end may be based on receiving a signal indicative that regulating the environment is no longer needed or desired. For example, the indication may be generated based on a user interaction that shuts down the storage system 100 (e.g., turning it off), removal of the lid 120, detecting that the perishable object is no longer present in the environment, a change in the information indicative of the perishable object that the perishable object has been removed from the environment, etc. If such an indication is received, the process 900 ends. Otherwise, the process 900 may return to step 920. Thus, process 900 permits for continuous regulation of environmental conditions in real-time.

FIG. 10 is a flow chart illustrating a process 1000 for regulating temperature in an environment in accordance with various embodiments of the present application. In some embodiments, the process 1000 may be performed as part of, for example, process 900. In other embodiments, the process 1000 may be performed individually. In certain embodiments, the process 1000 may be performed by the storage system 100 illustrated in FIGS. 1A-1C discussed above. For example, the process 1000 may drive one or more heat pumps 420 to adjust a temperature of an environment in chamber 122 based, in part, on a temperature difference between a current temperature of the environment and the target temperature.

At the start, process 1000 may determine a target temperature based on a perishable object within the environment. Determining the target temperature may be similar to that described above in connection to step 910 of FIG. 9.

At step 1005, a heat pump is selected to be controlled under the process 1000. For example, step 1005 may select one of the one or more heat pumps to be controlled. In some embodiments, all of the heat pumps may be controlled in parallel and/or simultaneously. In some embodiments, each of the heat pumps may be controlled in individually, one after the other or in overlapping fashion. In certain embodiments, a counter (i) may be utilized where each heat pump is associated with a value of “i.” The counter may be increased by whole integers, increasing “i” from 0 (e.g., a first selected heat pump), 1, 2, 3, etc. through the total number of heat pumps.

At step 1010, a calibration process is executed. In certain embodiments, step 1010 configures hardware components of the storage system 100 to pre-determined calibrated states and determines differential imbalances between output results and expected results of, for example, temperature sensors and heat pumps. Certain hardware components include expected variations in outputs (e.g., low cost temperature sensors may produce expected variations in the temperature accuracy of outputs due to produce process variations), thus step 1010 may account for such imbalances.

At step 1015, an output indicative of a current temperature may be received from one or more temperature sensors. In certain embodiments, the control circuitry 330 may query a temperature sensor associated with the thermally conductive plate 412 and a temperature sensor associated with the environment of the chamber 122 (e.g., one of temperature sensors 460 and/or 462). The temperature sensors may transmit an output to control circuity 300 indicative of the current temperature at the thermally conductive plate 412 and chamber 122, from which corresponding current temperatures can be determined.

At step 1020, a temperature difference of the environment is determined and stored. The temperature difference (sometimes referred to as an error term or “errTerm”) may be based on the difference between the current temperature in the environment from step 1015 and the target temperature, for example, retrieved in step 1025. For example, the errTerm may be calculated by subtracting the current temperature from the target temperature. The target temperature may be retrieved from a database and/or a look up table via the control circuitry 330. Step 1025 may also comprise retrieving a target differential (sometimes referred to herein as “Ts_dTarget”) between the temperature in the environment and a temperature of the thermally conductive plate 412, and a scaling factor for use in determining an error term for a control feed-back loop and control coefficients for the control feed-back loop.

The temperature difference may be determined based, in part, on a limiter differential. At step 1020, a limiter differential is determined (sometimes referred to herein as a limiter term or “limTerm”), based on the difference between the current temperature in the environment and the temperature of the thermally conductive plate 412 from step 1015. For example, the limTerm may be calculated by subtracting the temperature of the environment from the temperature of the thermally conductive plate 412. The target temperature may be retrieved from a database and/or a look up table via the control circuitry 330.

At step 1030, the limTerm is compared to the Ts_dTarget. If the limTerm is greater than Ts_dTarget (step 1030), then a scaling factor may be applied to the errTerm from step 1020 and is set as the errTerm (step 1035). The scaling factor (sometimes referred to herein as “limTermFactor”) may be a factor to apply to the control feed-back loop and may cause the control feed-back loop to temporarily reduce a control gain. Otherwise, the errTerm remains as determined in step 1020.

At step 1040, a control differential is determined. For example, the control differential (sometimes referred to herein as a “ctrlTerm”) may be calculated and stored using a control feed-back loop where the errTerm and Ts_dTarget are inputs in the control feed-back loop executed based on the control coefficients from step 1025. The purpose of the control feed-back loop is to drive the temperature to the target temperature by adjusting the control term based on the inputs to converge on the target temperature.

For example, in certain implementations a proportional-integral-derivative (PID) controller may be used as the control feed-back loop. Here, a process variable may be the measured temperature of the environment in the chamber 122. The process set-point may be the target temperature for the environment based on the perishable object stored in the chamber 122. The process variable is subtracted from the process set-point to determine the errTerm, as described above, and a correction can be applied based on a proportional term, an integral term, and a derivative term (e.g., control coefficients). The process controller-output (e.g., the control differential) may correspond to an electrical power to be supplied for driving the heat pump 420 to induce a temperature change in the chamber 122. Thus, the PID controller may be configured to drive the heat pump 420 such that the process variable (e.g., current temperature in the environment) converges at the process set-point by adjusting the process controller-output (e.g., supplied electrical power to the heat pump 420).

The control differential may be communicated in a control signal, for example, to a power management unit to drive the heat pump 420. The power management unit may supply the electrical power to the selected heat pump (step 1005) to induce the desired temperature change based on the errTerm. For example, the amount of electrical power may be increased to cause a first side of a heat pump to increase in temperature. The electrical power may be decreased once the current temperature approaches the desired temperature. The directional flow of electrical power (e.g., current) may also be reversed to change the direction of thermal energy flow (e.g., decrease temperature).

In some embodiments, the heat pumps may be thermoelectric heat pumps comprising an efficiency trend. The trend may be that a given heat pumping efficiency is significantly better with low control voltages than with high control voltages. However, conventional systems utilize control methods where a heat pump is subjected to voltage modulation between a high voltage, operating at a static On state of a single voltage level, or Off state. However, these methods fail to utilize the efficiencies in power usage and temperature changes achieved by operating such heat pumps dynamically and at lower voltages. Accordingly, embodiments herein provide for managing the temperature of the environment and temperature differential between the environment and the thermally conductive plate by using the process 1000 to determine control differentials for heat pumps. Non-limiting advantages of embodiments herein include, but are not limited to, minimizing the DC power consumption and condensation (e.g., smaller and controlled temperature differentials between surfaces and the environment). Additionally, the algorithm permits for the use of low cost sensors via the calibration step and the use of low cost heat-pumps with methods of failure detection (as described below).

Returning to process 1000, at step 1045 the control differential is limited to ensure it does not exceed functional limits of the selected heat pump. For example, operating specifications including a maximum operational control setting (“ctrlTermMax”) for the selected heat pump may be retrieved (step 1050) by the control circuitry 330 from a database and/or look up table. The ctrlTerm may be compared to the ctrlTermMax, and the ctrlTerm is then set to the lower of the ctrlTerm or the ctrlTermMax. Thus, limiting the ctrlTerm to the maximum operational settings of the heat pump.

At step 1055, the ctrlTerm as set in step 1045 is deployed to the selected heat pump. For example, the control circuitry 330 may transmit a control signal comprising the ctrlTerm to a power management unit. The power management unit supplies electrical power to the heat pump in accordance with the ctrlTerm so to drive the heat pump to generate a desired temperature at a surface of the heat pump.

At step 1060, the heat pump is monitored for failure, for example, based on a determination whether the adjusted temperature is converging on the target temperature (e.g., whether the control feed-back loop is failing to converge). In an example implementation, the decision may be based on whether the crtlTerm is greater than then the crtrTermMax multiplied by a control term fail factor (“ctrltermFailFactor”). The ctrlTermFailFactor may be included in the operating specifications retrieved in step 1050. If failure is detected, the failure is reported (step 1065). Reporting may comprise storing an indication of failure in a memory of the control circuitry 330, displaying a failure on a user interface 180, sounding an acoustic alarm and/or visual indicator such as a flashing light, etc.

If no failure is detected, then at step 1070 the process determines whether to quit or not. A determination to quit (e.g., stop process 1000) may be based on a command from a higher process (e.g., process 900 or other), a user input to power down the device and/or stop temperature control, etc. If step 1070 returns “Y”, the process proceeds to step 1075, where the heat pumps are reset and enter a standby mode, for example, to a minimum operational control setting (“ctrlTermMin”). The ctrlTermMin may be included in the operation specifications retrieved in step 1050. If step 1070 returns “N”, then at step 1080 the counter (i) is incremented by one and the next heat pump is selected and the process repeats.

FIG. 11 is a flow chart illustrating a process 1100 for regulating temperature in an environment in accordance with various embodiments of the present application. In some embodiments, the process 1100 may be performed as part of, for example, process 900. In other embodiments, the process 1100 may be performed individually. In certain embodiments, the process 1100 may be performed by the storage system 100 illustrated in FIGS. 1A-1C discussed above. For example, the process 1100 may drive one or more fans 440 to generate a fluid flow substantially parallel to a direction of alignment of a plurality of fins 435 included as part of a heat exchanger 430.

At the start, process 1100 may determine a target temperature differential (sometimes referred to herein as “TSD_dTarget”) between the inlet and outlet sides of the heat exchanger 430. In some embodiments, the target temperature differential is based on maintaining an ambient temperature across a first side of the one or more heat pumps 420 disposed on the heat exchanger 430. Determining the target temperature differential may be similar to that described above in connection to step 910 of FIG. 9.

In some implementations, the target temperature differential may be based on achieving a desired efficiency of the heat pumps 420. The target temperature differential between the outlet and inlet sides of the heat exchanger 430 may be based on operating the heat pumps 420 at their most efficient power setting. In some embodiments, the target differential may be approximately 6° C. or less, and more preferably, approximately 3° C. or less, and more preferably still approximately 0° C. In some implementations, a trade-off may be present between achieving a lower differential that may require more air flow and an increase in noise generated by the fans 440.

In some embodiments, process 1100 may be implemented to maintain the desired target temperature differential includes maintaining an ambient temperature across a first side of the one or more heat pumps 420, where a second side opposite the first side may draw heat from or transfer heat to the environment in response to driving the first heat pump (e.g., process 1000 of FIG. 10). In some embodiments, control of the one or more fans 440 may be based on the heat drawn from or transferred to the environment by the one or more heat pumps 420. For example, as the one or more heat pumps operate, heat energy may be drawn from the heat exchanger 430 and/or transferred to the heat exchanger 430. This may affect the temperature differential across the heat exchanger (e.g., expelled fluid flow may be at a higher temperature then at the inlet position). Thus, fan 440 may be operated in accordance with process 1100 to maintain the target temperature differential (e.g., ambient temperature) across the heat exchanger.

At step 1105, a fan is selected to be controlled under the process 1100. For example, step 1105 may select one of the one or more fans 440 to be controlled. In some embodiments, all of the fans 440 may be controlled in parallel and/or simultaneously. In some embodiments, each of the fans 440 may be controlled in individually, one after the other or in overlapping fashion. In certain embodiments, a counter (i) may be utilized where each heat pump is associated with a value of “i.” The counter may be increased by whole integers, increasing “i” from 0 (e.g., a first selected fan), 1, 2, 3, etc. through the total number of heat pumps.

At step 1110, a calibration process is executed. In certain embodiments, step 1110 configures hardware components of the storage system 100 to pre-determined calibrated states and determines differential imbalances between output results and expected results of, for example, temperature sensors. Certain hardware components include expected variations in outputs (e.g., low cost temperature sensors may produce expected variations in the temperature accuracy of outputs due to produce process variations), thus step 1110 may account for such imbalances.

At step 1115, an output indicative of a current temperature may be received from one or more temperature sensors. In certain embodiments, the control circuitry 330 may query a temperature sensor positioned at first side of the heat exchanger (e.g., sensor 464 at the inlet position 433 of FIG. 4C) and a temperature sensor a temperature sensor positioned at second side of the heat exchanger (e.g., sensor 466 at the outlet position 437 of FIG. 4C). The temperature sensors may transmit an output to control circuity 300 indicative of the current temperature at the inlet position and outlet position of the heat exchanger from which corresponding current temperatures can be determined.

At step 1120, a differential error term is determined based on the temperature differential across the heat exchanger (e.g., between the inlet and outlet positions) and the target temperature differential. The differential error term (sometimes referred to as an error term or “DerrTerm”) may be determined from the difference between the current temperatures at the inlet and outlet positions from step 1115 subtracted from the TSD_dTarget, for example, retrieved in step 1125. For example, the errTerm may be calculated by, first, subtracting the inlet position temperature from the outlet position temperature and, second, subtracting the resulting current temperature differential from TSD_dTarget. The target temperature differential may be retrieved from a database and/or a look up table via the control circuitry 330.

The differential error term may be used by a control feed-back loop in step 1130 to induce a change in the temperature differential across the heat exchanger when, for example, the error term calculation is negative (e.g., the temperature differential across the heat exchanger exceeds the target temperature differential). For example, at step 1130, a differential control term is determined based on the differential error term and control coefficients. For example, the differential control term (sometimes referred to herein as a “ctrlDTerm”) may be calculated and stored using a control feed-back loop (e.g., as described above in connection with step 1040 of FIG. 10). For example, in a PID controller the process variable, which may be differential temperature between the outlet and inlet, is subtracted from the process set-point, which may be the target temperature differential (TSD_dTarget), to determine errDTerm. A correction may be applied to the errDTerm using PID terms (e.g., control coefficients from step 1125) to determine a controller-output. In this embodiment, the controller-output is the differential control term that may correspond to power to be supplied to the at least one fan 440 for adjusting the temperature differential across the heat exchanger 430. The purpose of the control feed-back loop is to drive the measured temperature differential across the heat exchanger 430 to the target temperature differential by adjusting the controller-output (e.g., differential control term) to converge on the target temperature differential.

The differential control term may be communicated as part of a control signal transmitted, for example, to a power management unit to drive the at least one fan 440. The differential control term may represent an amount of voltage to be supplied to the selected fan (step 1105) for driving the fan 440 at a rotation rate and/or operating frequency to induce the desired change in the temperature differential between the inlet and outlet positions based on the control feed-back loop. For example, the amount of voltage may be increased to increase a rate of rotation, generating an increased fluid flow, and to reduce the temperature differential (e.g., lower the temperature at the outlet based on the fluid flow). Similarly, the voltage may be decreased to decrease the rate of rotation and/or permit the at least one fan to cease operation when the temperature differential is within the target temperature differential. Thus, the ctrlDTerm may correspond to a rate of rotation for driving the at least one fan 440 to induce adjustments to the temperature differential between the inlet and outlet positions and maintain the desired target temperature differential.

In some embodiments, the ctrlDTerm may also include frequency of operating at least one fan. For example, when the DerrTerm is less than or equal to the TSD_dTarget term, then the at least one fan need not be driven and the frequency of this operation may be included in the ctrlDTerm.

At step 1135, the ctrlDTerm is limited to ensure it does not exceed functional limits of the selected fan. For example, operating specifications including a maximum operational control setting (“ctrlFTermMax”) for the selected fan may be retrieved (step 1140) by the control circuitry 330 from a database and/or look up table. The ctrlDTerm may be compared to the ctrlFTermMax, and the ctrlDTerm is then set to the lower of the ctrlDTerm or the ctrIFTermMax. Thus, limiting the ctrlDTerm to the maximum operational settings of the fan.

At step 1145, the ctrlDTerm as set in step 1135 is deployed to the selected fan. For example, the control circuitry 330 may transmit a control signal comprising the ctrlDTerm to a power management unit. The power management unit supplies a voltage to the fan in accordance with the ctrlDTerm so to drive the fan at the desired rate of rotation. At step 1150, the fan is monitored for failure, for example, based on a determination whether the adjusted temperature differential between the inlet and outlet portions is converging with the target temperature differential (e.g., whether the control feed-back loop is failing to converge). In an example implementation, the decision may be based on whether the crtlDTerm is greater than then the crtrFTermMax multiplied by a control fan term fail factor (“ctrlFtermFailFactor”). The ctrlFTermFailFactor may be included in the operating specifications retrieved in step 1140. If failure is detected, the failure is reported (step 1155). Reporting may comprise storing an indication of failure in a memory of the control circuitry 330, displaying a failure on a user interface 180, sounding an acoustic alarm and/or visual indicator such as a flashing light, etc.

If no failure is detected, then at step 1160 the process determines whether to quit or not. A determination to quit (e.g., stop process 1100) may be based on a command from a higher process (e.g., process 900 or other), a user input to power down the device and/or stop temperature control, etc. If step 1160 returns “Y”, the process proceeds to step 1165, where the fans are reset and enter a standby mode, for example, to a minimum fan operational control setting (“ctrlFTermMin”). The ctrlFTermMin may be included in the operation specifications retrieved in step 1140. If step 1160 returns “N”, then at step 1080 the counter (i) is incremented by one and the next heat pump is selected and the process repeats.

In certain embodiments, process 1100 may provide effective and efficient heat energy transfer from the heat exchanger while obscuring acoustic signatures. For example, effective heat transfer may be achieved by maintaining the temperature at the outlet position to be no lower than the temperature at the inlet position or the temperature at the outlet position to be no higher than the temperature at the inlet. Efficiency in power usage may be achieved by controlling the fan 440 operation to ensure that the temperature differential is not too small (e.g., avoid constant On states and/or high rate of rotations). Thus, dynamically adjusting the operation of the at least one fan 440 based on real-time and active measurements of the temperature differential across the heat exchanger improves efficiencies and effectiveness heat transfer. Efficient transfer of heat may facilitate improved temperature control throughout the other components and systems. Additionally, certain implementations of the process 1100 may minimize and reduce the observability of the storage system 100 (e.g., minimize intrusive sounds). For example, observations and intrusive sounds are more likely to occur with sharp or sudden changes in operation of the fans 440, however process may limit sudden or sharp changes by controlling operation of the at least one fan 440 at rates slower than the attention span of the observer.

Conventional systems that do not utilize embodiment of process 1100 typically run at constant rotational rates, regardless of the actual need of fluid flow over the heat exchanger. Thus, where the heat exchanger has excess heat energy and more fluid flow is needed, the conventional is ineffective because the rotational rate is not adjusted and the system must cease operation of the heat pumps to reduce heat energy. In cases where the heat exchangers temperature is equal to the ambient temperature and less fluid flow is needed, the conventional systems are also inefficient because they use excessive power to continue to operate the fan at rates that are higher than necessary.

FIG. 12 is a flow chart illustrating an example process 1200 for regulating humidity in an environment in accordance with various embodiments of the present application. In some embodiments, the process 1200 may be performed as part of, for example, process 900. In other embodiments, the process 1200 may be performed individually. In certain embodiments, the process 1200 may be performed by the storage system 100 illustrated in FIGS. 1A-1C discussed above.

For example, the process 1200 may determine an amount of gaseous fluid (e.g., water vapor in some embodiments) to add or remove from the environment within the chamber 122 to maintain a target relative humidity level. Process 1200 may be implemented to increase a relative humidity level by controlling the humidity control system 320 to vaporize liquid fluid to a gas to generate the determined amount of gaseous fluid. Process 1200 reduce the relative humidity level by controlling the temperature control system 310 to generate a temperature differential between the environment and a heat exchanger 410 that induces condensation of gaseous fluid in the chamber 122.

At the start, process 1200 may determine a target humidity level (sometimes referred to herein as “HS_dTarget”) based on a perishable object within the environment. Determining the target temperature may be similar to that described above in connection to step 910 of FIG. 9.

At step 1205, a humidity controller is selected to be controlled under the process 1000. For example, step 1205 may select one of the one or more heat pumps 420 of the temperature control system 400 to be controlled and/or the heating element 730 of the humidity control system 700. In some embodiments, each of the selectable controllers (e.g., the heat pumps and/or heating element) may be controlled in parallel and/or simultaneously, for example, based on a single control signal. In some embodiments, each may be controlled in individually based on a corresponding control signal, one after the other or in overlapping fashion. In certain embodiments, a counter (i) may be utilized where each heat pump is associated with a value of “i.” The counter may be increased by whole integers, increasing “i” from 0 (e.g., a first selected humidity controller), 1, 2, 3, etc. through the total number of heat pumps and/or heating element.

At step 1210, a calibration process is executed. In certain embodiments, step 1210 configures hardware components of the storage system 100 to pre-determined calibrated states and determines differential imbalances between output results and expected results of, for example, temperature sensors, heat pumps, and heating elements. Step 1210 may include step 1010 for calibrating, for example, the temperature sensors 460 and 462 and heat pumps 420 of the temperature control system 400. Additionally, step 1210 may calibrate, for example, temperature sensor 460, humidity sensors (e.g., sensors 460, 462, 840, etc.), and heating element 730 of the humidity control system 700 and/or 800. As described above, step 1210 may permit the use of low cost sensors, heat pumps, and heating elements with methods of calibration and failure detection.

At step 1215, an output indicative of a relative humidity level of the environment may be received from at least one humidity sensor. In certain embodiments, the control circuitry 330 may query a humidity sensor associated with the chamber 122. The humidity sensor may transmit an output to control circuity 300 indicative of the current relative humidity level within the chamber 122, from which a current relative humidity level can be determined.

At step 1220, a humidity differential is determined and stored. The humidity differential (sometimes referred to as an error term or “errHTerm”) may be based on the difference between the current relative humidity level in the chamber from step 1215 and the target relative humidity level based on the perishable object, for example, retrieved in step 1225. For example, the errHTerm may be calculated by subtracting the current relative humidity level from the target relative humidity level. The target relative humidity level may be retrieved from a database and/or a look up table via the control circuitry 330. Step 1225 may also comprise retrieving control coefficients for the control feed-back loop for use in determining an error term for a control feed-back loop (e.g., FIG. 15).

At step 1230, a control term (sometimes referred to herein as “ctrlBorCTerm”) is determined. For example, the ctrlBorCTerm may be determined and stored using a control feed-back loop (e.g., as described above in connection with step 1040 of FIG. 10), where measure relative humidity is the process variable, the HS_dTarget is the process-set point, and a controller-output (e.g., ctrlBorCTerm) is determined by applying control coefficients from step 1225 (e.g., PID terms) to the errHterm. The purpose of the control feed-back loop is to determine whether to the relative humidity should be increased or decreased and engage either the humidity control system 320 or the temperature control system 310, respectively.

Furthermore, the determined control term (e.g., controller-output) may be either the supply voltage for driving the heating element 430 to increase the relative humidity level in the chamber 122 via vaporization, or the supply electrical power for driving the heat pump 420 to decrease the relative humidity level in the chamber 122 via condensation. For example, the control term may be included a control signal communicated, for example, to a power management unit. The power management unit may drive the heating element 430, based on the amount of voltage identified by the control term, to increase humidity. Similarly, the power management unit may drive the heat pump 420, based on the amount of electrical power identified by the control term, to decrease humidity.

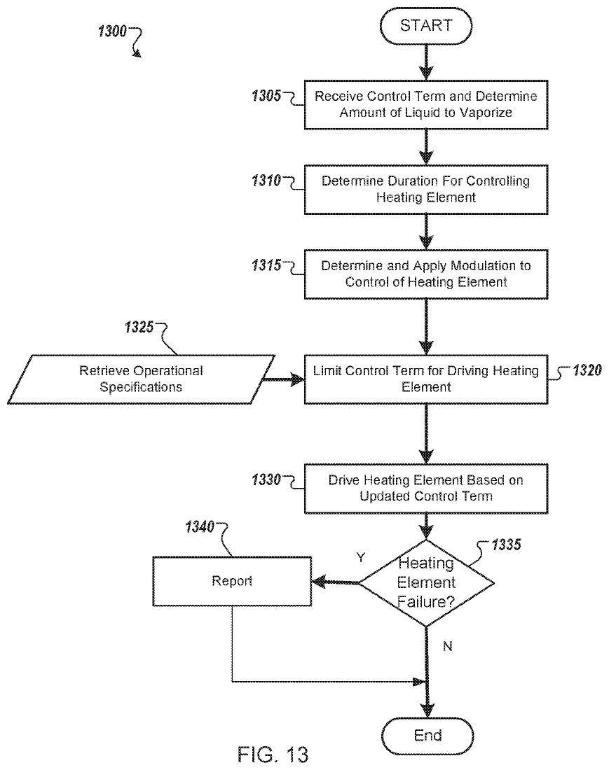

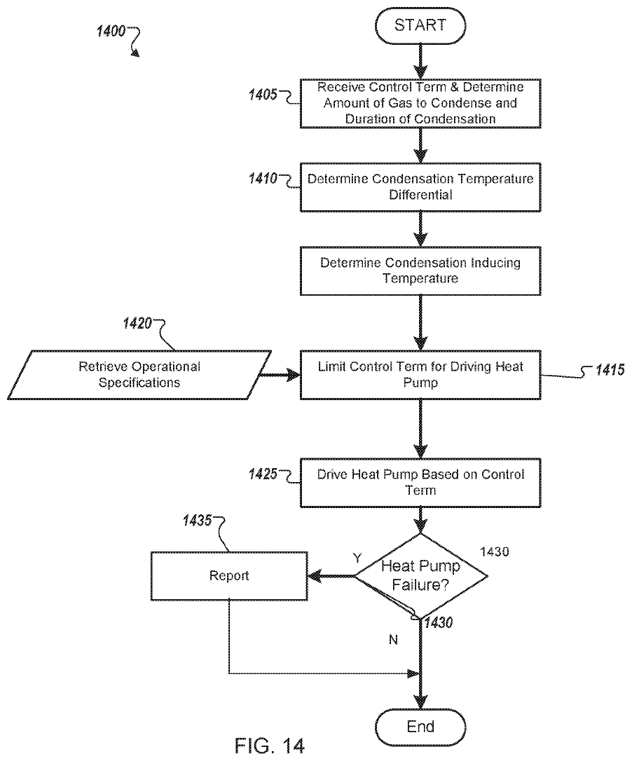

Thus, at step 1235, process 1200 determines to increase the relative humidity level within the chamber 122 based on the ctrlBorCTerm. If the relative humidity in the chamber 122 is below the target relative humidity, at step 1235 a determination is made to increase the humidity level by vaporizing an amount of liquid based on the humidity differential (step 1240) using, for example, the humidity control system 320. An example implementation of step 1240 may be performed using sub-process 1300 illustrated below in FIGS. 13. If the relative humidity in the chamber 122 is above the target relative humidity, at step 1245 a determination is made to decrease the humidity level by condensing an amount of vapor in the chamber 122 based on the humidity differential (step 1250) using, for example, the temperature control system 310. An example implementation of step 1250 may be performed using sub-process 1400 illustrated below in FIGS. 14.

Once the humidity level in the chamber 122 converges with the target humidity level (or no adjustment is necessary), at step 1255 a determination to quit may be based on a command from a higher process (e.g., process 900 or other), a user input to power down the device and/or stop temperature control, etc. If step 1255 returns “Y”, the process proceeds to step 1260, where the humidity control system 320 and temperature control system 310 are reset and enter a standby mode, for example, to a minimum operational control settings including a minimum setting for the heat pumps (e.g., a “ctrlCTermMin”) and heating element (e.g., a “ctrlBTermMin”). The ctrlCTermMin may be substantially similar to the ctrlTermMin from FIG. 10. The minimum operational control settings may be included in operation specifications retrieved in step 1265 from, for example, a database and/or look up table. If step 1260 returns “N”, then at step 1270 the counter (i) is incremented by one and the next humidity controller is selected and the process repeats.

FIG. 13 is a flow chart illustrating an example sub-process 1300 for increasing relative humidity levels in an environment in accordance with various embodiments of the present application. The sub-process 1300 may be performed as part of a larger process for regulating the relative humidity level within a chamber 122 such as processes 1200 of FIG. 12 all discussed herein. The sub-process 1300 may be performed by a control circuitry such as example computer system 1650 illustrated in FIG. 16 discussed below.

At step 1305, a control signal may be received and an amount of liquid to be vaporized may be determined. For example, a control signal comprising the control term determined in step 1230 of FIG. 12 may be received. The control signal may comprise the errHTerm indicating the humidity differential. The humidity differential, representative of the difference between a current humidity level and the target humidity level, may correspond to an amount of liquid to vaporize to cause the relative humidity level to converge with the target humidity level. For example, vaporizing one milliliter of water may increase the relative humidity level from 85% to 95% in a chamber that has approximately 800 liters of air at 15° C. Correspondence between an amount of liquid to vaporize and corresponding influence on the relative humidity level for a given liquid can be found in psychrometric curves, which are stored in a database. In some embodiments, the control circuitry 330 may access the database to retrieve the amount of liquid to vaporize based on the determined increase in relative humidity level for a given liquid.

At step 1310, a duration of time for controlling the heating element 430 is determined and stored. The duration of time may be based on a rate of capillary action and the determined amount of liquid from step 1305. For example, as described in connection to FIG. 7, the determined amount of liquid may be drawn to the heating element 730 via capillary action using an article 750. The article 750 may comprise a rate of capillary action that is based on the material and composition of the article 750. The rate of capillary action may also be based on heating the heating element 730. That is, as liquid in contact with the heating element vaporizes, additional liquid is brought into contact with the heating element via the article 750. The control term may be updated to include the determined duration of time for transmission as part of the control signal.

At step 1315, a modulation rate may be determined based on the rate of capillary action and a rate of vaporization and applied to the control term. In certain implementations, the rate of capillary action may be less than the rate at which the liquid is vaporized. Thus, the voltage supplied to the heating element may be modulated using a pulse-width-modulation. For example, the voltage to the heating element may be modulated between ON and OFF states. In an ON state, the heating element may vaporize liquid in contact therewith, while in an OFF state vaporizing does not occur. Thus, liquid can be drawn via capillary action to replace the vaporized liquid. Furthermore, if the heating element was not modulated, it may continue to heat the article 850 which could result in burning the article, damaging the article, starting a fire, etc. Thus, modulating the heating element according to a pulse-width-modulation may minimize and/or eliminate this risk. The control term may then comprise a duration of time for controlling the heating element that includes an amount of time in the ON state and an amount of time in the OFF state.

At step 1320, the control term for driving the heating element is limited to ensure the heating element does not exceed functional limits. For example, operating specifications including a maximum heating element operational control setting (“ctrlHETermMax”) for the heating element may be retrieved (step 1325) by the control circuitry 330 from a database and/or look up table. The control term in step 1315 may be compared to the ctrlHETermMax, and the control term is then updated to the lower of the control term or the ctrlHETermMax. Thus, limiting the control term to the maximum operational settings of the heating element.

At step 1330, the heating element is driven based on the control term as set in step 1325. For example, the control circuitry 330 may transmit a control signal comprising the control to a power management unit. The power management unit supplies a voltage to the heating element in accordance with the control term so to drive the heating element for the duration of time (and modulated as specified if needed) to vaporize the desired amount liquid.

At step 1335, the heating element is monitored for failure, for example, based on a determination whether the adjusted relative humidity level is converging on the target relative humidity level (e.g., whether the control feed-back loop is failing to converge). In an example implementation, the decision may be based on whether the control term is greater than then the crtrHETermMax multiplied by a heating element control term fail factor (“ctrlHEtermFailFactor”). The ctrlHETermFailFactor may be included in the operating specifications retrieved in step 1325. If failure is detected, the failure is reported (step 1340). Reporting may comprise storing an indication of failure in a memory of the control circuitry 330, displaying a failure on a user interface 180, sounding an acoustic alarm and/or visual indicator such as a flashing light, etc. The process then ends and, for example, may proceed to step 1255 of FIG. 12.

FIG. 14 is a flow chart illustrating an example sub-process 1400 for decreasing relative humidity levels in an environment in accordance with various embodiments of the present application. The sub-process 1400 may be performed as part of a larger process for regulating the relative humidity level within a chamber 122 such as processes 1200 of FIG. 12 all discussed herein. The sub-process 1400 may be performed by a control circuitry such as example computer system 1650 illustrated in FIG. 16 discussed below.

At step 1405, a control signal may be received, an amount of gas to be condensed may be determined, and a duration for condensation may be calculated. For example, a control signal comprising the control term determined in step 1230 of FIG. 12 may be received. The control signal may comprise the errHTerm indicating the humidity differential. The humidity differential, representative of the difference between a current humidity level and the target humidity level, may correspond to an amount of gas to condense into liquid to cause the relative humidity level to converge with the target humidity level. As described in connection to FIG. 13, correspondence between an amount of liquid to condense and a corresponding influence on relative humidity levels for a given liquid can be found in psychrometric curves stored in a database and access by the control circuity. Furthermore, the rate at which gas in the chamber 122 can be condensed to a liquid may also be determined, for example, based on the on psychrometric curves and a condensation inducing temperature for a given gaseous fluid. The control term may be updated to include the determined duration of time for transmission as part of the control signal.

At step 1415, a condensation inducing temperature differential is determined. The condensation inducing temperature differential may be based on a model including a plurality of temperature differentials that correspond to differences between a plurality of temperatures of the heat exchanger 410 (e.g., thermally conductive plate 412) and a plurality of temperatures of the environment within the chamber 122. In certain embodiments, the condensation inducing temperature differential may be determined based on receiving a temperature reading and/or humidity reading from the environment (e.g., sensors 460-466 of FIGS. 4A-4C) and identifying the corresponding condensation inducing temperature differential. For example, psychometric curves may be based on a temperature reading and a humidity reading

From the condensation inducing temperature differential, a condensation inducing temperature can be determined (step 1420). For example, a given temperature and humidity in the environment may correspond given condensation inducing temperature differential, which may define a given temperature that for that heat exchanger 410 that induces condensation. In certain embodiments, the condensation inducing temperature may be the temperature at which the body of the thermally conductive plate 412 should be at to induce condensation along its surface. For example, condensation may occur along the thermally conductive plate 412 when a temperature of the thermally conductive plate 412 reaches a condensation inducing temperature due to cooling by, for example, drawing heat from the thermally conductive plate 412 into the one or more heat pumps 420.

At step 1425, a control term for driving the heat pumps may be determined. For example, the control term may be based on a difference between the current temperature of the heat exchanger 410 and the condensation inducing temperature. In some embodiments, the difference may be between the current temperature of the thermally conductive plate 412 (e.g., sensor 462 in contact with the thermally conductive plate 412) and the condensation inducing temperature.

In some implementations, the control term may also be based on a control differential. For example, the control term may be limited based on the control differential to ensure heat pump does not exceed functional limits. For example, operating specifications including a maximum operational control setting (“ctrlTermMax”) for the selected heat pump may be retrieved by the control circuitry 330 from a database and/or look up table. The current control term may be compared to the ctrlTermMax, and then set to the lower of the current control term or the ctrlTermMax. Thus, limiting the ctrlTerm to the maximum operational settings of the heat pump.

At step 1430, the control as set in step 1425 is deployed to the selected heat pump. For example, the control circuitry 330 may transmit a control signal comprising the control term to a power management unit. The power management unit may supply electrical power to the heat pump in accordance to drive the heat pump based on the control term such that the temperature of the heat exchanger 410 is equal to or below the condensation inducing temperature. For example, the heat pump 420 may be supplied with an electrical power to cause the temperature of the first side to decrease and draw heat energy from the thermally conductive plate 412. The heat pump 420 may be driven for the determined duration of time such that the temperature of the thermally conductive plate 412 is reduced to or below the condensation inducing temperature and for an amount of time to condense the desired amount of vapor.

At step 1435, the driven heat pump is monitored for failure, for example, based on a determination whether the adjusted relative humidity level is converging on the target relative humidity level (e.g., whether the control feed-back loop is failing to converge). In an example implementation, the decision may be based on whether the control term is greater than then the crtrTermMax multiplied by a control condensation term fail factor (“ctrlCtermFailFactor”). The ctrlCTermFailFactor may be included in the operating specifications retrieved in step 1425. If failure is detected, the failure is reported (step 1440). Reporting may comprise storing an indication of failure in a memory of the control circuitry 330, displaying a failure on a user interface 180, sounding an acoustic alarm and/or visual indicator such as a flashing light, etc. The process then ends and, for example, may proceed to step 1255 of FIG. 12.

For example, FIG. 15 illustrates an example wired or wireless processing system 1505 that may be used in connection with various embodiments described herein. For example, the system 1505 may be used as or in conjunction with a control circuitry or an interface system or its components as previously described herein. The system 1505 can be a conventional processing device, personal computer, computer server, personal digital assistant, smart phone, tablet computer, or any other processor enabled device that is capable of wired or wireless data communication. Other computer systems and/or architectures may be also used, as will be clear to those skilled in the art.

The system 1505 preferably includes one or more processors, such as processor 1515. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 1515.

The processor 1515 is preferably connected to a communication bus 1510. The communication bus 1510 may include a data channel for facilitating information transfer between storage and other peripheral components of the system 1505. The communication bus 1510 further may provide a set of signals used for communication with the processor 1515, including a data bus, address bus, and control bus (not shown). The communication bus 1510 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 1505 preferably includes a main memory 1220 and may also include a secondary memory 1525. The main memory 1520 provides storage of instructions and data for programs executing on the processor 1515. The main memory 1520 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 1525 may optionally include an internal memory 1530 and/or a removable medium 1535, for example a floppy disk drive, a magnetic tape drive, a compact disc (“CD”) drive, a digital versatile disc (“DVD”) drive, etc. The removable medium 1535 is read from and/or written to in a well-known manner. Removable storage medium 1535 may be, for example, a floppy disk, magnetic tape, CD, DVD, SD card, etc.

The removable storage medium 1535 is a non-transitory computer readable medium having stored thereon computer executable code (i.e., software) and/or data. The computer software or data stored on the removable storage medium 1535 is read into the system 1505 for execution by the processor 1515.

In alternative embodiments, secondary memory 1525 may include other similar means for allowing computer programs or other data or instructions to be loaded into the system 1505. Such means may include, for example, an external storage medium 1550 and an interface 1540. Examples of external storage medium 1550 may include an external hard disk drive or an external optical drive, or and external magneto-optical drive.

Other examples of secondary memory 1525 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 1535 and communication interface 1555, which allow software and data to be transferred from an external medium 1550 to the system 1505.

System 1505 may also include an input/output (“I/O”) interface 1540. The I/O interface 1540 facilitates input from and output to external devices. For example, the I/O interface 1540 may receive input from a touch screen, buttons, knobs, user input devices, voice commands, keyboard or mouse and may provide output to a display 1580. The I/O interface 1540 is capable of facilitating input from and output to various alternative types of human interface and machine interface devices alike.

System 1505 may also include a communication interface 1545. The communication interface 1545 allows software and data to be transferred between system 1505 and external devices (e.g. printers), networks, or information sources. For example, computer software or executable code may be transferred to system 1505 from a network server via communication interface 1545. Examples of communication interface 1545 include a modem, a network interface card (“NIC”), a wireless data card, a communications port, a PCMCIA slot and card, an infrared interface, and an IEEE 1394 fire-wire, just to name a few.

Communication interface 1545 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 1545 are generally in the form of electrical communication signals 1560. These signals 1560 are preferably provided to communication interface 1545 via a communication channel 1555. In one embodiment, the communication channel 1555 may be a wired or wireless network, or any variety of other communication links. Communication channel 1555 carries signals 1560 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 1520 and/or the secondary memory 1525. Computer programs can also be received via communication interface 1545 and stored in the main memory 1520 and/or the secondary memory 1525. Such computer programs, when executed, enable the system 1505 to perform the various functions of the present invention as previously described.

In this description, the term “computer readable medium” is used to refer to any non-transitory computer readable storage media used to provide computer executable code (e.g., software and computer programs) to the system 1505. Examples of these media include main memory 1520, secondary memory 1525 (including internal memory 1530, removable medium 1535, and external storage medium 1550), and any peripheral device communicatively coupled with communication interface 1545 (including a network information server or other network device). These non-transitory computer readable mediums are means for providing executable code, programming instructions, and software to the system 1505.

In an embodiment that is implemented using software, the software may be stored on a computer readable medium and loaded into the system 1505 by way of removable medium 1535, I/O interface 1540, or communication interface 1545. In such an embodiment, the software is loaded into the system 1505 in the form of electrical communication signals 1560. The software, when executed by the processor 1515, preferably causes the processor 1515 to perform the inventive features and functions previously described herein.

The system 1505 also includes optional wireless communication components that facilitate wireless communication over a voice and over a data network. The wireless communication components comprise an antenna system 1565, a radio system 1570 and a baseband system 1575. In the system 1505, radio frequency (“RF”) signals are transmitted and received over the air by the antenna system 1565 under the management of the radio system 1570.

In one embodiment, the antenna system 1565 may comprise one or more antennae and one or more multiplexors (not shown) that perform a switching function to provide the antenna system 1565 with transmit and receive signal paths. In the receive path, received RF signals can be coupled from a multiplexor to a low noise amplifier (not shown) that amplifies the received RF signal and sends the amplified signal to the radio system 1570.

In alternative embodiments, the radio system 1570 may comprise one or more radios that are configured to communicate over various frequencies. In one embodiment, the radio system 1570 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 1570 to the baseband system 1575.

If the received signal contains audio information, then baseband system 1575 decodes the signal and converts it to an analog signal. Then the signal is amplified and sent to a speaker. The baseband system 1575 also receives analog audio signals from a microphone. These analog audio signals are converted to digital signals and encoded by the baseband system 1575. The baseband system 1575 also codes the digital signals for transmission and generates a baseband transmit audio signal that is routed to the modulator portion of the radio system 1570. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 1565 where the signal is switched to the antenna port for transmission.

The baseband system 1575 is also communicatively coupled with the processor 1515. The central processing unit 1515 has access to data storage areas 1520 and 1525. The central processing unit 1515 is preferably configured to execute instructions (i.e., computer programs or software) that can be stored in the memory 1520 or the secondary memory 1525. Computer programs can also be received from the baseband processor 1575 and stored in the data storage area 1520 or in secondary memory 1525, or executed upon receipt. Such computer programs, when executed, enable the system 1505 to perform the various functions of the present invention as previously described. For example, data storage areas 1520 may include various software modules (not shown) that are executable by processor 1515.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

1. A system for storing a perishable object, the system comprising:
an enclosure body comprising a housing including a base and at least one sidewall forming a cavity;
a lid which removably engages with at least a portion of the enclosure body to form a chamber enclosing an environment surrounding the perishable object;
a thermal insulator disposed within the cavity;
a temperature control system disposed within the cavity to adjust a temperature of the environment based on a target temperature range associated with the perishable object, the temperature control system comprising:
one or more heat pumps, and
a first heat exchanger thermally coupled to the environment, at least a part of the first heat exchanger positioned apart from the one or more heat pumps by the thermal insulator and thermally coupled to the one or more heat pumps via a conduit extending through the thermal insulator; and
a humidity control system disposed within the cavity, the humidifying system comprising a heating element in contact with a liquid to adjust a humidity of the environment based on a target humidity range associated with the perishable object.

2.-4. (canceled)

5. The system of claim 1, wherein the temperature control system comprises a controller having a memory and at least one processor communicatively coupled to one or more temperature sensors, the controller configured to receive outputs from the one or more temperature sensors and automatically adjust the temperature of the environment based, at least in part, on the outputs from the one or more temperature sensors.

6. The system of claim 1, wherein the temperature control system comprises:
a second heat exchanger positioned on a side of the one or more heat pumps opposite the first heat exchanger, the second heat exchanger comprising a plurality of fins extending from the one or more heat pumps toward the base of the housing, wherein the plurality of fins are aligned in a first direction; and
at least one fan arranged to generate a fluid flow in the first direction across a surface area of the plurality of fins.

7. The system of claim 1, wherein the one or more heat pumps comprise at least one heat pump configured to influence the temperature in the environment based on at least one of a Peltier Effect or a Carnot Cycle.

8. The system of claim 1, wherein the one or more heat pumps comprises a plurality of thermoelectric heat pumps disposed on at least a second heat exchanger, wherein the second heat exchanger is positioned on a side of the thermoelectric heat pumps opposite the first heat exchanger of the temperature control system.

9. The system of claim 8, wherein the at least a part of the first heat exchanger comprises a thermally conductive plate that is substantially parallel to the plurality of thermoelectric heat pumps, and the temperature control system further comprises a thermal conductor corresponding to each thermoelectric heat pump, wherein each thermal conductor extends from the thermally conductive plate to a corresponding thermoelectric heat pump via a corresponding conduit through the thermal insulator.

10. The system of claim 9, further comprising a collection element positioned between the thermally conductive plate and the thermoelectric heat pumps, the collection element arranged to receive condensation from the thermally conductive plate.

11. The system of claim 10, wherein the collection element comprises a channel arranged to guide at least a portion of the condensation to a reservoir of the humidity control system configured to store the liquid.

12. The system of claim 1, wherein the humidity control system comprises a controller having a memory and at least one processor communicatively coupled to at least one humidity sensor, the controller configured to receive an output from the at least one humidity sensor and adjust the humidity of the environment based, at least in part, on the output from the at least one humidity sensor.

13. The system of claim 1, wherein the humidity control system comprises at least a first chamber, wherein the first chamber comprises an article that uses capillary action to bring a portion of the liquid into contact with the heating element that is configured to heat the liquid to a first temperature to generate vapor.

14. The system of claim 13, wherein the humidity control system further comprises a channel through which the vapor passes from the first chamber into the environment, wherein a nozzle is positioned at an end of the channel proximal the environment and the nozzle is heated to a second temperature above the first temperature and the nozzle is configured to increase the temperature of the vapor.

15.-16. (canceled)

17. The system of claim 1, wherein the enclosure body further comprises a cap positioned above the first heat exchanger.

18.-21. (canceled)

22. The system of claim 17, wherein the cap comprises a plurality of through holes extending from the top surface and through the cap toward the first heat exchanger of the temperature control system, wherein the through holes are configured to increase the thermal coupling of the first heat exchanger of the temperature control system to the environment.

23. The system of claim 22, wherein the cap comprises thermally conductive material deposited within the through holes and in contact with the first heat exchanger.

24. The system of claim 17, further comprising a plate positioned between the first heat exchanger and the cap, wherein the plate is in contact with an upper surface of the first heat exchanger and a lower surface of the cap.

25. (canceled)

26. The system of claim 1, further comprising a user interface comprising a display configured to present information representative of at least one of a temperature or a humidity of the environment.

27.-70. (canceled)

71. A method for regulating temperature of an environment surrounding a perishable object, the method comprising:
determining a target temperature for the environment based on a desired temperature for the perishable object, wherein the perishable object is enclosed in a lid removably engaged with at least a portion of an enclosure body to form a chamber enclosing the environment;
driving at least a first heat pump thermally coupled to the environment to adjust the temperature of the environment based, in part, on a first temperature difference between a first temperature in the environment and the target temperatures
wherein the first heat pump is one of a plurality of heat pumps, and driving a second heat pump of the plurality of heat pumps to adjust the temperature of the environment based, in part, on a second temperature difference between a second temperature in the environment and the target temperature, the first and second heat pumps thermally coupled to the environment.

72. (canceled)

73. The method of claim 71, further comprising driving the second heat pump after the first heat pump.

74.-97. (canceled)

98. A method for regulating humidity of an environment surrounding a perishable object, the method comprising:
determining target humidity for the environment based on a desired humidity for the perishable object, wherein the perishable object is enclosed in a lid removably engaged with at least a portion of an enclosure body to form a chamber enclosing the environment;
determining whether to increase or decrease humidity in the environment based on a humidity differential between a current humidity in the environment and the target humidity;
in response to determining to increase humidity in the environment, determining an amount of liquid to vaporize based on an amount of vapor to minimize the humidity differential;
drawing the determined amount of liquid to the one or more heating elements via capillary action and an article in contact with the one or more heating elements, and heating the one or more heating elements to a first temperature to vaporize the amount of liquid to generate the amount of vapor; and
driving one or more heating elements to vaporize the amount of liquid and adjust humidity of the environment based on said determination.

99.-103. (canceled)

104. The method of claim 98, further comprising, in response to determining to decrease humidity in the environment:
determining an amount of vapor to condense to liquid based on minimizing the humidity differential;
determining a duration of condensation based on the determined amount of vapor;
determining a condensation inducing temperature for a heat exchanger thermally coupled to one or more heat pumps based on a current temperature of the environment and a condensation temperature differential to condense liquid of a given temperature, and
driving the one or more heat pumps based on the condensation inducing temperature for the duration such that a temperature of the heat exchange is equal to or below the condensation inducing temperature.
